(19) United States
(12) Patent Application Publication
(10) Pub. No.: US 2026/0370263 A1
(43) Pub. Date: Nov. 19, 2026

(54) MAXIMUM LAYER CONFIGURATIONS TO ADAPT JCS MULTI-LAYER INTERFERENCES

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US); Hyojin LEE, San Diego, CA (US)

(21) Appl. No.: 19/139,824

(22) PCT Filed: Mar. 10, 2023
(86) PCT No.: PCT/CN2023/080730

§ 371 Date: Jun. 16, 2025

(51) Int. Cl. H04B 7/04; H04W 72/21

(52) U.S. Cl. CPC H04B 7/04013; H04W 72/21

(57) ABSTRACT

Apparatuses and methods for maximum layer configurations to adapt JCS multi-layer interferences are described. An apparatus is configured to obtain a set of layer parameters for MIMO JCS based on a MIMO sensing configuration, where the set of layer parameters corresponds to a maximum number of layers for at least one of a number of cells associated with the UE or a number of BWPs utilized for the MIMO JCS by the UE. The apparatus is also configured to select a number of layers for a sensing operation based on the set of layer parameters and an operational condition, where the sensing operation is associated with the MIMO JCS by the UE. The apparatus is further configured to measure sensing measurement data associated with at least one sensing target for the sensing operation according to the number of layers.

### CROSS-REFERENCE TO RELATED APPLICATION(S)

This application is a 371 National Stage of PCT Application No. PCT/CN2023/080730, filed on Mar. 10, 2023, entitled “MAXIMUM LAYER CONFIGURATIONS TO ADAPT JCS MULTI-LAYER INTERFERENCES”, and assigned to the assignee hereof. The disclosure of the prior Application is considered part of and is incorporated by reference into this Patent Application.

### TECHNICAL FIELD

The present disclosure relates generally to communication systems, and more particularly, to wireless communications utilizing joint communication and sensing (JCS).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to obtain a set of layer parameters for multiple-input multiple-output (MIMO) joint communication and sensing (JCS) based on a MIMO sensing configuration, where the set of layer parameters corresponds to a maximum number of layers for at least one of a number of cells associated with a user equipment (UE) or a number of bandwidth parts (BWPs) utilized for the MIMO JCS by the UE. The apparatus is also configured to select a number of layers for a sensing operation based on the set of layer parameters and an operational condition, where the sensing operation is associated with the MIMO JCS by the UE. The apparatus is further configured to measure sensing measurement data associated with at least one sensing target for the sensing operation according to the number of layers.

In the aspect, the method includes obtaining a set of layer parameters for MIMO JCS based on a MIMO sensing configuration, where the set of layer parameters corresponds to a maximum number of layers for at least one of a number of cells associated with the UE or a number of BWPs utilized for the MIMO JCS by the UE. The method also includes selecting a number of layers for a sensing operation based on the set of layer parameters and an operational condition, where the sensing operation is associated with the MIMO JCS by the UE. The method further includes measuring sensing measurement data associated with at least one sensing target for the sensing operation according to the number of layers.

In an additional aspect of the disclosure, a method, a computer-readable medium, and an apparatus are provided. The apparatus is configured to receive, from a UE, an indication of a UE capability associated with MIMO JCS. The apparatus is also configured to configure the UE, based on the indication of the UE capability, with a MIMO sensing configuration that indicates a set of layer parameters for the MIMO JCS, where the set of layer parameters corresponds to a maximum number of layers for at least one of a number of cells associated with the UE or a number of BWPs utilized for the MIMO JCS by the UE.

In the aspect, the method includes receiving, from a UE, an indication of a UE capability associated with MIMO JCS. The method also includes configuring the UE, based on the indication of the UE capability, with a MIMO sensing configuration that indicates a set of layer parameters for the MIMO JCS, where the set of layer parameters corresponds to a maximum number of layers for at least one of a number of cells associated with the UE or a number of BWPs utilized for the MIMO JCS by the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating examples of inter-layer interference and processing for JCS, in accordance with various aspects of the present disclosure.

FIG. 6 is a call flow diagram for wireless communications, in accordance with various aspects of the present disclosure.

FIG. 7 is a diagram illustrating example call flow diagrams for wireless communications, in accordance with various aspects of the present disclosure.

FIG. 8 is a diagram illustrating example modes and BWPs in JCS, in accordance with various aspects of the present disclosure.

FIG. 9 is a diagram illustrating example operations for JCS, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

Wireless communication networks, such as a 5G NR network, may enable positioning measurements and operations to locate wireless devices and sensing targets. For example, a wireless communication network, a wireless device on a wireless communication network, and/or the like, may utilize JCS operations for communications and sensing. Configuring multiple layers for communication operations may increase information throughput, such as for data and control information. For MIMO operations, configurations such as single-user (SU) MIMO (SU-MIMO) and multi-user (MU) MIMO (MU-MIMO) may include transmitted signals with multiple layers. Similarly, signals transmitted via orthogonal frequency division multiplexing (OFDM) may include multiple layers.

Configuring multiple layers for sensing operations may increase information throughput, however, it may also result in higher inter-layer interference therebetween and impact sensing performance (e.g., accuracy, etc.). That is, the inter-layer interference may be proportional to the number of layers in the sensing operations. Further, the handling of inter-layer interference between layers may impact the performance of wireless systems and devices in, and on, a wireless communication network. For instance, increased complexity and time for inter-layer interference cancellation processing may impact system and device efficiency/performance, and may also increase delays in signal transmissions.

Various aspects relate generally to wireless communications systems and positioning/sensing operations for wireless devices. Some aspects more specifically relate to maximum layer configurations to adapt JCS multi-layer interferences. In one example, a UE may obtain a set of layer parameters for MIMO JCS based on a MIMO sensing configuration. The set of layer parameters may correspond to a maximum number of layers for at least one of a number of cells associated with the UE or a number of BWPs utilized for the MIMO JCS by the UE. The UE may also select a number of layers for a sensing operation based on the set of layer parameters and an operational condition, where the sensing operation is associated with the MIMO JCS by the UE, measure sensing measurement data associated with at least one sensing target for the sensing operation according to the number of layers. In another example, a network node (e.g., a base station) may receive, from a UE, an indication of a UE capability associated with MIMO JCS, and configure the UE, based on the indication of the UE capability, with a MIMO sensing configuration that indicates a set of layer parameters for the MIMO JCS. The set of layer parameters may correspond to a maximum number of layers for at least one of a number of cells associated with the UE or a number of BWPs utilized for the MIMO JCS by the UE.

Particular aspects of the subject matter described in this disclosure can be implemented to realize one or more of the following potential advantages. In one example, by configuring a maximum number of layers for MIMO JCS sensing operations, the described techniques can be used to maintain sensing accuracy and performance while not overly increasing complexity for systems, devices, and/or

operations. In another example, by basing the configurations for the maximum number of layers in MIMO JCS sensing operations on operational conditions of the wireless network/devices, the described techniques can be used to situationally and/or dynamically utilize a maximum number of layers with respect to types of sensing, specific cells, a BWP(s) used for sensing, and/or the like, while minimizing inter-layer interference between the layers.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

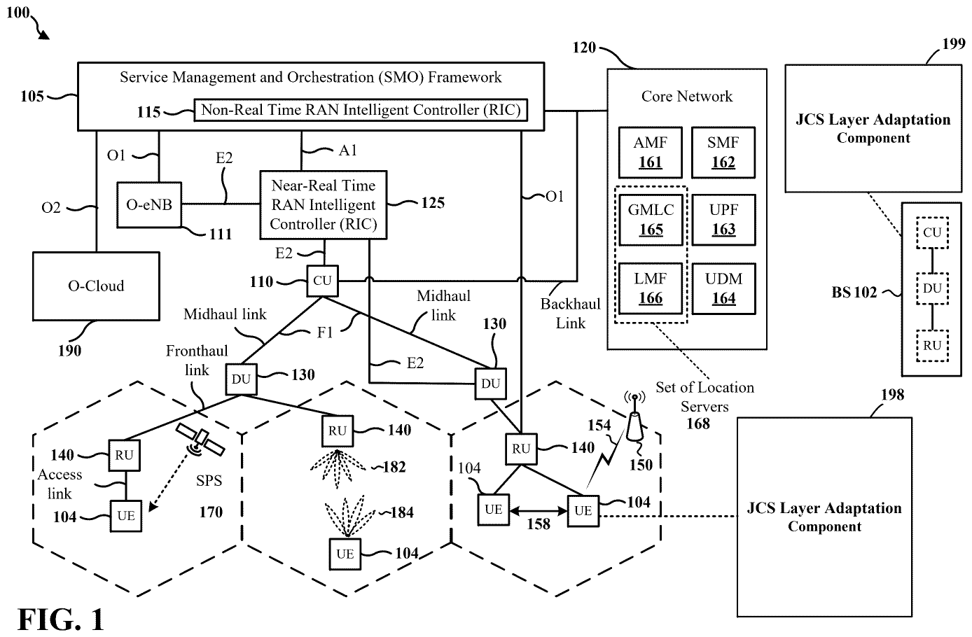

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a JCS layer adaptation component 198 (“component 198”) that may be configured to obtain a set of layer parameters for multiple-input multiple-output (MIMO) joint communication and sensing (JCS) based on a MIMO sensing configuration, where the set of layer parameters corresponds to a maximum number of layers for at least one of a number of cells associated with a user equipment (UE) or a number of bandwidth parts (BWPs) utilized for the MIMO JCS by the UE. The component 198 may also be configured to select a number of layers for a sensing operation based on the set of layer parameters and an operational condition, where the sensing operation is associated with the MIMO JCS by the UE. The component 198 may be further configured to measure sensing measurement data associated with at least one sensing target for the sensing operation according to the number of layers. The component 198 may be configured to operate in a first BWP of the number of BWPs according to at least one of: the UE capability of the UE, at least one of the amount of the sensing resolution or the amount of the sensing accuracy for motion tracking in the first BWP, or the number of sensing targets for the sensing operation, where to operate in the first BWP of the number of BWPs, the component 198 may be configured to switch from a second BWP of the number of BWPs to the first BWP, and where the number of layers that is selected corresponds to the number of sensing targets for the sensing operation. The component 198 may be configured to transmit, for a network node, a conflict indication associated with the first maximum number of layers and the second maximum number of layers through at least one of UE assistance information (UAI) via a medium access control (MAC) control element (MAC-CE) or uplink control information (UCI) via a physical uplink control channel (PUCCH). The component 198 may be configured to transmit, for a network node, an indication of a UE capability of the UE associated with the MIMO JCS, where to obtain the set of layer parameters for the MIMO JCS, the component 198 may be configured to: receive, from the network node, the set of layer parameters based on the UE capability. The component 198 may be configured to measure other sensing measurement data associated with at least one other sensing target for at least one other sensing operation prior to obtaining the set of layer parameters for the MIMO JCS, where to measure the sensing measurement data, the component 198 may be configured to measure the sensing measurement data, based on the MIMO sensing configuration, with at least one of a different BWP or a different sensing operation type compared to measuring the other sensing measurement data associated with the at least one other sensing target for the at least one other sensing operation. In certain aspects, the base station 102 may have a JCS layer adaptation component 199 (“component 199”) that may be configured to receive, from a UE, an indication of a UE capability associated with MIMO JCS. The component 199 may also be configured to configure the UE, based on the indication of the UE capability, with a MIMO sensing configuration that indicates a set of layer parameters for the MIMO JCS, where the set of layer parameters corresponds to a maximum number of layers for at least one of a number of cells associated with the UE or a number of BWPs utilized for the MIMO JCS by the UE. The component 199 may be configured to receive, from the UE, a conflict indication associated with the first maximum number of layers and the second maximum number of layers through at least one of UAI via MAC-CE or UCI via a physical uplink control channel PUCCH. The component 199 may be configured to select a number of layers for a sensing operation based on at least one of the set of layer parameters or an operational condition of the UE associated with the indication of the UE capability, where the sensing operation is associated with the MIMO JCS. The component 199 may be configured to measure sensing measurement data associated with at least one sensing target for the sensing operation according to the number of layers. The component 199 may be configured to operate in a first BWP of the number of BWPs according to at least one of: the UE capability of the UE, at least one of the amount of the sensing resolution or the amount of the sensing accuracy for motion tracking in the first BWP, or the number of sensing targets for the sensing operation, where to operate in the first BWP of the number of BWPs, the component 199 may be configured to switch from a second BWP of the number of BWPs to the first BWP, and where the number of layers that is selected corresponds to the number of sensing targets for the sensing operation. The component 199 may be configured to measure other sensing measurement data associated with at least one other sensing target for at least one other sensing operation prior to configuring the UE with the MIMO sensing configuration, where to measure the sensing measurement data, the component 199 may be configured to measure the sensing measurement data, based on the indication of the UE capability, with at least one of a different BWP or a different sensing operation type compared to measuring the other sensing measurement data associated with the at least one other sensing target for the at least one other sensing operation. That is, aspects herein provided for maximum layer configurations to adapt JCS multi-layer interferences enable wireless network devices to more efficiently to accurately and efficiently perform multi-layer sensing for JCS through management of inter-layer interference. A UE may obtain a set of layer parameters for MIMO JCS based on a MIMO sensing configuration, and the set of layer parameters may correspond to a maximum number of layers for at least one of a number of cells associated with the UE or a number of BWPs utilized for the MIMO JCS by the UE. The UE may also select a number of layers for a sensing operation based on the set of layer parameters and an operational condition, where the sensing operation is associated with the MIMO JCS by the UE, measure sensing measurement data associated with at least one sensing target for the sensing operation according to the number of layers. A network node (e.g., a base station) may receive, from a UE, an indication of a UE capability associated with MIMO JCS, and configure the UE, based on the indication of the UE capability, with a MIMO sensing configuration that indicates a set of layer parameters for the MIMO JCS. The set of layer parameters may correspond to a maximum number of layers for at least one of a number of cells associated with the UE or a number of BWPs utilized for the MIMO JCS by the UE.

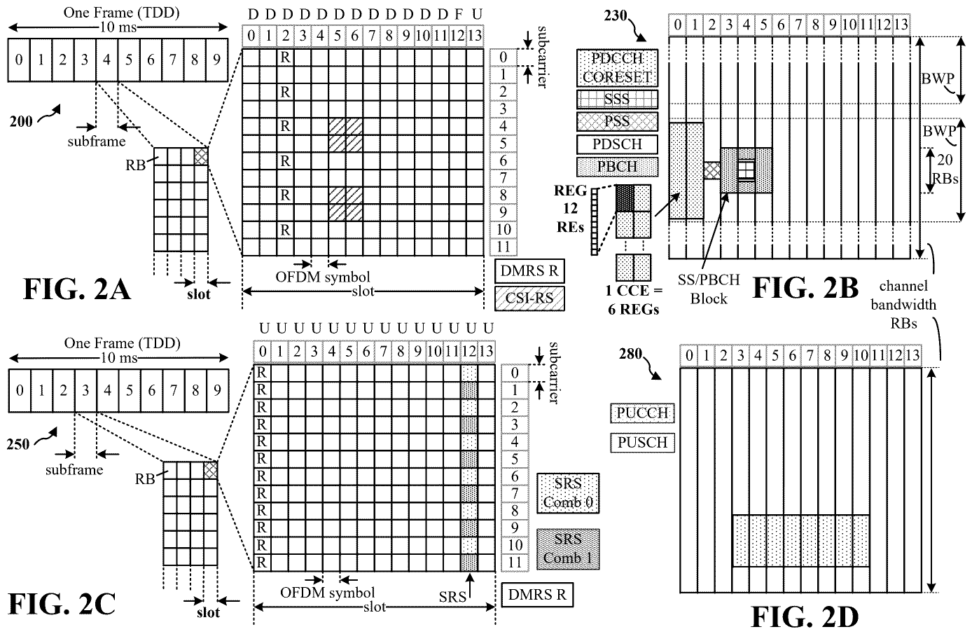

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

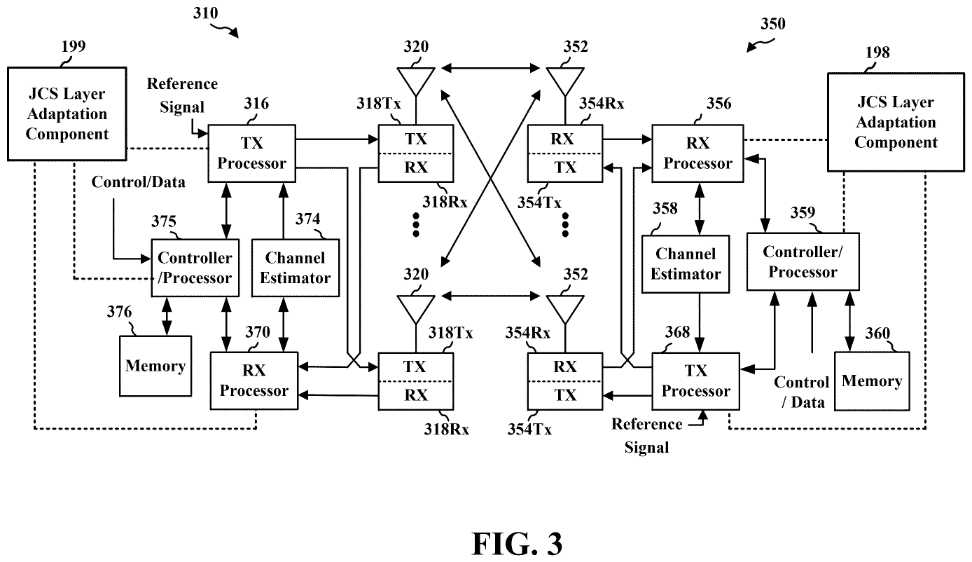

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

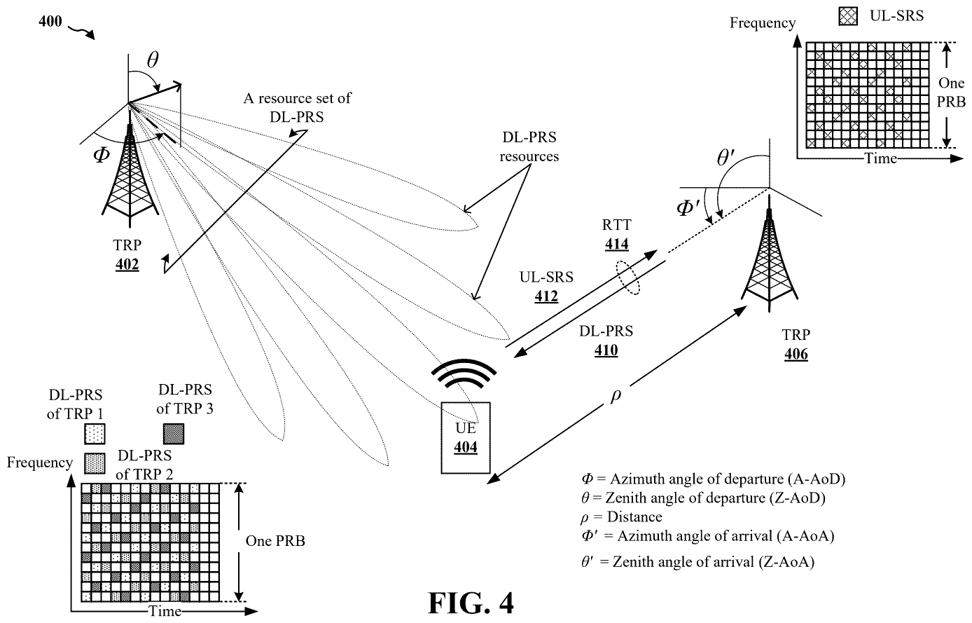

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on |T_{SRS_RX}−T_{PRS_TX}|−|T_{SRS_TX}−T_{PRS_RX}|. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In JCS operations for communications and sensing, configuring multiple layers for communication operations may increase information throughput, such as for data and control information (e.g., in MIMO operations: SU-MIMO and/or MU-MIMO).

Similarly, signals transmitted/received via OFDM may include multiple layers. However, while configuring multiple layers for sensing operations may increase information throughput, it may also result in higher inter-layer interference therebetween and impact sensing performance (e.g., accuracy, etc.) due to the inter-layer interference being proportional to the number of layers in the sensing operations. The handling of inter-layer interference between layers may also impact the performance of wireless systems and wireless devices through increased complexity and time for inter-layer interference cancellation processing (e.g., impacts system and device efficiency/performance), and may also increase delays in signal transmissions.

Aspects described herein for maximum layer configurations to adapt JCS multi-layer interferences may provide enhancements to signaling accuracy, signaling latency, and/or processing power/complexity, as well as improving layer selection and utilization for types of sensing, specific cells, a BWP(s) used for sensing, and/or the like, while minimizing inter-layer interference between the layers.

Accordingly, aspects introduce configurations for the maximum utilized number of layers in MIMO JCS sensing operations that allows for sensing accuracy and efficiency, as well as flexibility in configuring for cells/BWPs, while mitigating impacts for inter-layer interference between the layers. For instance, the aspects described provide for the selection of a maximum number of layers for cells and/or BWPS that are utilized in sensing operations, e.g., mono-/bi-static sensing, based on configured layer parameters. In aspects, a sensing operation may be an operation where a sensing node transmits a sensing signal/waveform, e.g., a waveform by which the sensing of targets may be performed (e.g., RADAR)), via reflections/echo (e.g., monostatic) and/or other interactions of the transmission itself with the target (bistatic). In aspects, a communication operation may be an operation where a wireless device, base station, and/or the like, transmit and/or receive data/control communications via communication waveforms (e.g., a waveform by which the data/control communications may be provided, such as OFDM). Corresponding sensing measurement data for targets based on the selected number of layers provide both sensing accuracy and reduced operation complexity/latency. Aspects may provide for a UE to receive configuration elements via RRC signaling, and may utilize the element “maxMIMO-Layers-JCS” to configure the number of layers per a given cell, BWP (e.g., PRB), etc., for a data tone such as a PDSCH. Aspects also provide for different modes within the “maxMIMO-Layers-JCS” element for shared or individual communication and sensing resource (e.g., via “maxMIMO-Layers-JCS-mode1” and “maxMIMO-Layers-JCS-mode2”). Aspects may also provide configurations for numbers of layers based on the type of the sensing operations, e.g., mono-/bi-static sensing, and may provide selection rules in configurations for simultaneously enabled mono-/bi-static sensing in a given resource. Aspects may further provide for handling data transmission/sensing conflicts and reporting of UE capabilities for communications and/or sensing. Utilizing the configurations for the maximum utilized number of layers in MIMO JCS sensing operations, the described aspects may maintain sensing accuracy with minimal impact to processing efficiency or inter-layer interference between the layers.

While various aspects may be described in the context of configurations to adapt JCS multi-layer interferences for descriptive and illustrative purposes, aspects are not so limited and may be applicable to other types of resources and operations, as would be understood by persons of skill in the relevant art(s) having the benefit of this disclosure.

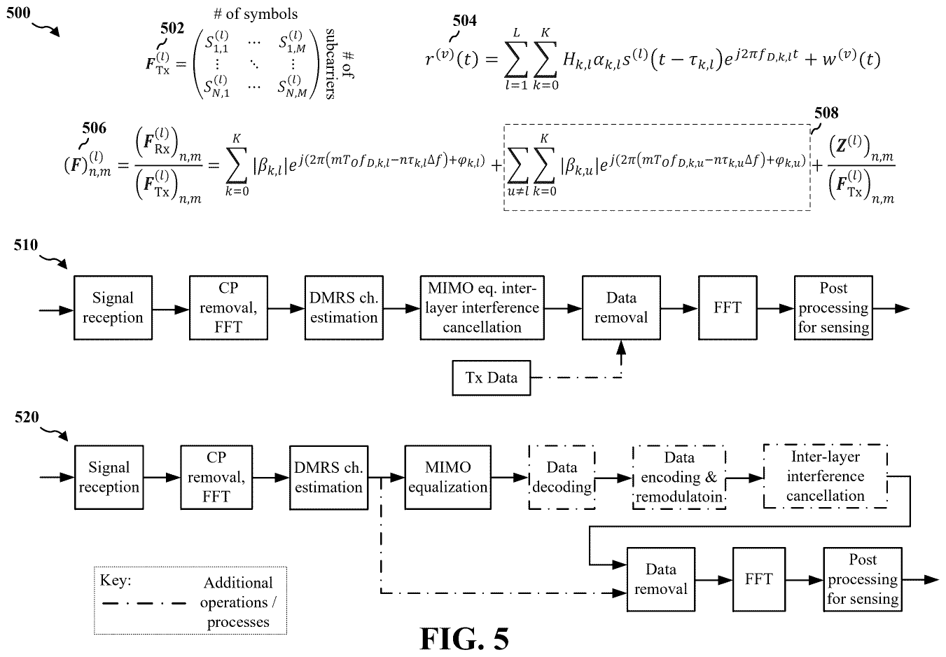

FIG. 5 is a diagram 500 illustrating examples of inter-layer interference and processing for JCS, in accordance with various aspects of the present disclosure. When multiple layers are configured in JCS for sensing, the inter-layer interference may impact the sensing performance. For SU-MIMO and MU-MIMO operations, transmitted signals may have multiple layers. As shown in diagram 500, by way of example and with reference to a processing flow 510, a representation 502, with columns of numbers of probing signals and rows of numbers of subcarriers, may represent a number of layers for a transmitted signal in multi-layer OFDM within a layer index ‘1’.

Likewise, received signals may include multiple layers. With reference to a representation 504 in diagram 500, a demodulation reference signal (DMRS) may be transmitted and received with orthogonal resources for different layers, and data tones for different layers may be super-positioned on received antennas (where ‘v’ is the Rx antenna index). Subsequent to CP removal, FFT processing, and MIMO equalization, the representation 504 may be reformed as a representation 506 that includes an inter-layer interference element 508. By applying a two dimensional FFT to representation 506, the delay-Doppler profile may be determined, followed by post processing to yield sensing information.

When encountering multi-layer interference in JCS, e.g., as represented by inter-layer interference element 508 that may be proportional to the number of layers utilized in the signal, inter-layer cancellation may be leveraged to enhance the restored sensing information. Such a solution may be represented as two cases: the processing flow 510 and a processing flow 520. In the case of monostatic sensing and the processing flow 510, a base station or UE may already be aware of what signal is transmitted on each layer, and therefore, as shown in the processing flow 510, the sensing information may be extracted by the additional operation/process of differentiating the Tx data and the received data.

In the case of bistatic sensing and the processing flow 520, the transmitted signal on each layer may first be detected by a base station or UE in order to have knowledge thereof. As shown in the processing flow 520, the base station or UE may first, as additional operations/processes, reconstruct the ideal (or true) data, and further, may differentiate the reconstructed data with the received data. Such processing of the processing flow 520 may be highly dependent on the base station or UE self-implementation, and such implementation may include large additional effort, processing, time, etc., to extract the sensing information. Thus, the UE capability and operation may be impacted. As one example, interference cancellation complexity may severely impact a receiver of a UE.

Accordingly, other aspects herein enable maximum layer configurations to adapt JCS multi-layer interferences that provide enhancements to signaling accuracy, signaling latency, and/or processing power/complexity, as well as improving layer selection and utilization for types of sensing, specific cells, a BWP(s) used for sensing, and/or the like, while minimizing inter-layer interference between the layers.

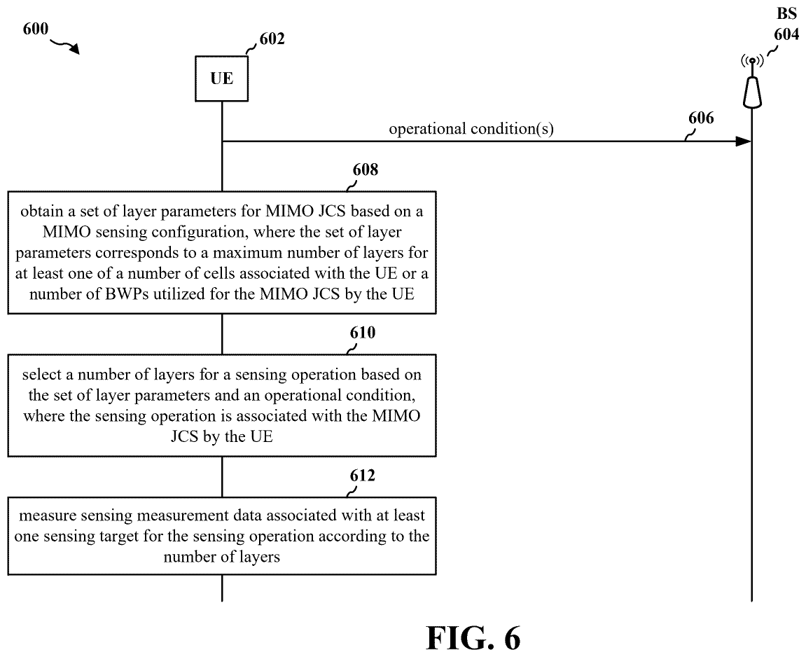

FIG. 6 is a call flow diagram 600 for wireless communications, in accordance with various aspects of the present disclosure. Call flow diagram 600 illustrates maximum layer configurations to adapt JCS multi-layer interference for a UE (e.g., a UE 602) that may communicate and/or perform bistatic sensing operations via JCS with a network node (a base station 604, such as a gNB or other type of base station, by way of example, as shown), and/or that may perform monostatic sensing. Aspects described for the base station 604 may be performed by the base station in aggregated form and/or by one or more components of the base station 604 in disaggregated form. Additionally, or alternatively, the aspects may be performed by the UE 602 autonomously, in addition to, and/or in lieu of, operations of the base station 604.

In the illustrated aspect, the UE 602 may be configured to provide/transmit an operational condition(s) 606 associated with the UE 602 to the base station 604. For instance, the UE 602 may be configured to provide/transmit to be received by the base station 604 the operational condition(s) 606 that include, without limitation, an amount of sensing resolution, an amount of sensing accuracy, a UE capability of the UE 602 (e.g., including a UE capability of the UE 602 associated with the MIMO JCS), a number of sensing targets (e.g., objects on which a sensing node directs sensing operations), a traffic burden, and/or the like. With regard to operational conditions for sensing operations, one or more metrics may be used to represent the sensing performance, e.g., speed (m/s), doppler (Hz), range (m), and/or the like. In aspects, a sensing resolution may refer to a granularity of a metric value obtained. As an example, for speed, a sensing resolution may be within 1 m/s, or 0.1 m/s, or 0.01 m/s, etc. Likewise, the sensing resolution of range may be within 1m, or 0.1 m, or 0.01 m, and/or the like. In aspects, sensing accuracy may represent how close a metric may be to an actual value, or may represent the error in a metric for a sensing operation. As one example, an actual speed of a target may be 10 m/s, while the estimated speed of a sensing operation may be 11 m/s. In such a case, the estimated speed would have a sensing accuracy within 10% of the actual speed; the error would be 1 m/s, and such error may represent the sensing accuracy, e.g., within 1 m/s. In some aspects, the UE capability (e.g., as included in the operational condition(s) 606) associated with the MIMO JCS of the UE 602 may indicate support for, or a lack of the UE capability to support, multiple layers in JCS. The UE 602 may be configured to report its maximum support layers for sensing, or its maximum supported layers for monostatic sensing and maximum supported layers for bi-static sensing. In aspects, the UE 602 may be configured to operate in a first BWP of a number of BWPs according to at least one of operational conditions 606, e.g., the UE capability of the UE 602, at least one of the amount of the sensing resolution or the amount of the sensing accuracy for motion tracking in the first BWP, the number of sensing targets for the sensing operation, and/or the like. In some aspects, the UE 602, to operate in the first BWP of the number of BWPs, may be configured to switch from a second BWP of the number of BWPs to the first BWP.

The UE 602 may be configured to obtain (at 608) a set of layer parameters for MIMO JCS based on a MIMO sensing configuration, where the set of layer parameters corresponds to a maximum number of layers for at least one of a number of cells associated with the UE or a number of BWPs utilized for the MIMO JCS by the UE 602. In aspects, the set of layer parameters may be received by the UE 602 from the base station 604, e.g., based on the operational condition(s) 606 of the UE 602, which may include the UE capability of the UE 602. In some aspects, the UE capability (e.g., as included in the operational condition(s) 606) associated with the MIMO JCS of the UE 602 may indicate a maximum layers supported for sensing, a maximum layers supported for mono-/bi-static sensing, a lack of the UE capability to support multiple layers in JCS, and/or the maximum number of layers for each of the number of cells associated with the UE or the number of BWPs utilized for the MIMO JCS by the UE 602. In aspects, where a lack of support is indicated by the UE capability, the maximum number of layers utilized for the MIMO JCS by the UE 602. In aspects, where a lack of support is indicated by the UE capability, the maximum number of layers utilized for the MIMO JCS by the UE 602 may be configured/selected as a single layer.

The set of layer parameters may be associated with (1) a single resource for communication operations and the sensing operation or (2) a first resource for the communication operations and a second resource for the sensing operation. In aspects, the set of layer parameters may be associated with the single resource for the communication operations and the sensing operation. The set of layer parameters may include a first layer parameter for a first maximum number of layers in the communication operations and a second layer parameter for a second maximum number of layers in the sensing operation. In aspects, the set of layer parameters may correspond to the maximum number of layers for a first cell of the number of cells associated with the UE and for a first BWP of the number of BWPs utilized for the MIMO JCS by the UE 602, and the set of layer parameters may include a first layer parameter for a first maximum number of layers associated with monostatic sensing and a second layer parameter for a second maximum number of layers associated with bistatic sensing. In such aspects, the first layer parameter for the first maximum number of layers associated with the monostatic sensing may have a value that is higher than the second layer parameter for the second maximum number of layers associated with the bistatic sensing, or the first layer parameter for the first maximum number of layers associated with the monostatic sensing may be unconstrained during the sensing operation when the sensing operation is monostatic.

In aspects, each of the number of BWPs utilized for the MIMO JCS by the UE 602 may be a PRB, where each PRB is configured by the MIMO sensing configuration via radio resource control (RRC) signaling from the base station 604. Each PRB may be configured by the MIMO sensing configuration with a respective layer parameter value for one or more layer parameters in the set of layer parameters. In aspects, a BWP of the number of BWPs may be configured for monostatic sensing and bistatic sensing, where the set of layer parameters may include a first layer parameter for a first maximum number of layers associated with the monostatic sensing and a second layer parameter for a second maximum number of layers associated with the bistatic sensing. In aspects, a BWP of the number of BWPs is configured for monostatic sensing and bistatic sensing, where the set of layer parameters includes a first layer parameter for a first maximum number of layers associated with the monostatic sensing and a second layer parameter for a second maximum number of layers associated with the bistatic sensing that is higher than the first maximum number of layers.

The UE 602 may be configured to select (at 610) a number of layers for a sensing operation based on the set of layer parameters and an operational condition, where the sensing operation is associated with the MIMO JCS by the UE 602. For instance, the UE 602 may be configured to select (at 610) a number of layers from the set of layers for the sensing operation based at least in part on the operational condition(s) 606. In aspects, the UE 602 may be configured to select (at 610) a number of layers that may correspond to the number of sensing targets for the sensing operation. In aspects, the UE 602 may be configured to select (at 610) the number of layers for the sensing operation as a minimum of the first maximum number of layers and the second maximum number of layers, as the second maximum number of layers based on a UE capability of the UE 602. In such aspects, the UE 602 may be configured to report, to the base station 604, conflict information, e.g., included in the operational condition(s) 606) that may be associated with the UE 602 having a MIMO configuration for a resource that indicates a maximum number of layers for both of sensing and data transmission, where the conflict information may include the number of layers selected (at 610) by the UE 602, e.g., for each PRB in a given cell, the first maximum number of layers, and/or the second maximum number of layers. The conflict information may be reported by the UE 602 as UAI via a MAC-CE and/or as UCI via a PUCCH. In some aspects, in the absence of a configuration for a maximum number of layers for sensing, the UE 602 may be configured to select (at 610) a number of layers that is specified for transmissions of data. In some aspects, the UE 602 may be configured to select (at 610) the set of layer parameters from a list of layer parameters.

The UE 602 may be configured to measure (at 612) sensing measurement data associated with at least one sensing target for the sensing operation according to the number of layers. In aspects, the UE 602 may be further configured to measure other sensing measurement data associated with at least one other sensing target for at least one other sensing operation prior to obtaining the set of layer parameters for the MIMO JCS. In such aspects, the UE 602 may be configured to measure the sensing measurement data based on the MIMO sensing configuration, with at least one of a different BWP or a different sensing operation type compared to measuring the other sensing measurement data associated with the at least one other sensing target for the at least one other sensing operation. In aspects, the UE 602 may be configured to perform monostatic sensing without the base station 604, to perform monostatic sensing with the base station 604, and/or to perform bistatic sensing in conjunction with the base station 604.

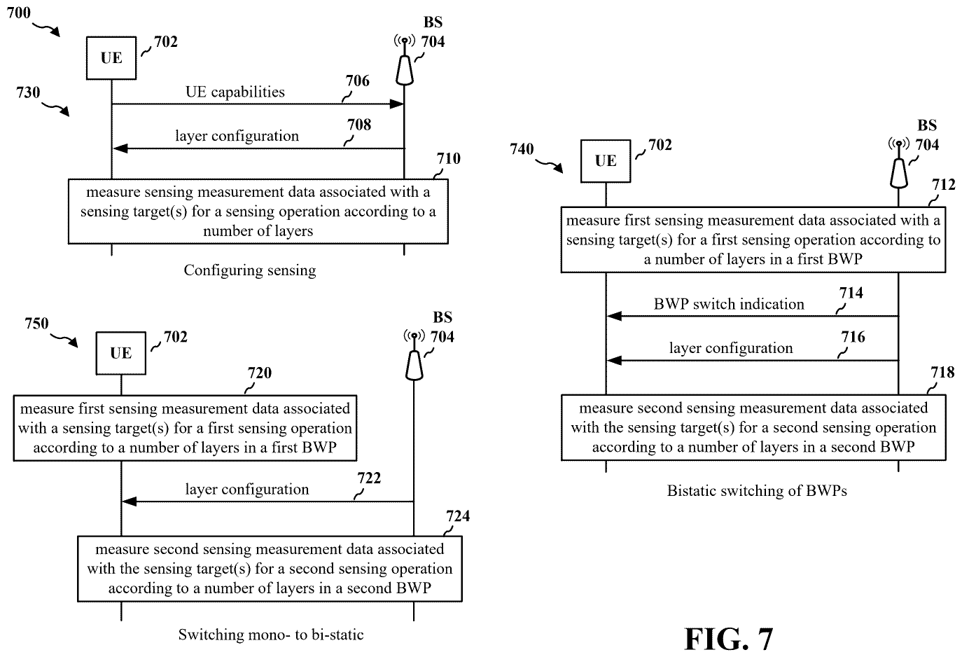

FIG. 7 is a diagram 700 illustrating example call flow diagrams for wireless communications, in various aspects. Diagram 700 includes a flow diagram 730, a flow diagram 740, and a flow diagram 750. The illustrated flow diagrams may represent, generally, various aspects described herein for maximum layer configurations to adapt JCS multi-layer interferences. The flow diagrams in diagram 700 are illustrated in the context of a UE (e.g., a UE 702) that may communicate and/or perform bistatic sensing operations via JCS with a network node (a base station 704, such as a gNB or other type of base station, by way of example, as shown), and/or that may perform monostatic sensing. Aspects described for the base station 704 may be performed by the base station in aggregated form and/or by one or more components of the base station 704 in disaggregated form. Additionally, or alternatively, the aspects may be performed by the UE 702 autonomously, in addition to, and/or in lieu of, operations of the base station 704.

The flow diagram 730 may represent the base station 704 configuring sensing aspects of the UE 702. For instance, the UE 702 may provide/transmit to the base station 704 one or more UE capabilities 706 of the UE 702 (e.g., as part of operational condition(s) associated with the UE 702, as described herein). In aspects, the UE capabilities 706 may be sensing capabilities of the UE 702. Based on the UE capabilities 706, the base station 704 may be configured to provide/transmit a layer configuration 708 to be received by the UE 702. The layer configuration 708 may be a MIMO sensing configuration and may enable the base station 704 to configure the UE 702 with a set of layer parameters for MIMO JCS operations. In aspects, the set of layer parameters may indicate a number(s) of layers for sensing operations for one or more sensing resources (e.g., a BWP(s)).

The UE 702 and/or the base station 704 may be configured to measure (at 710) sensing measurement data associated with a sensing target(s) for a sensing operation according to the number of layers. In one configuration, the UE 702 may be configured by the layer configuration 708 to perform monostatic sensing (e.g., at 710) with a configured number of layers in a sensing resource/BWP. In the configuration, the base station 704 may concurrently perform bistatic sensing (e.g., at 710) in association with the monostatic sensing (e.g., at 710) performed by the UE 702. In another configuration, the base station 704 may be configured to perform monostatic sensing (e.g., at 710) with a configured number of layers in a sensing resource/BWP. In the configuration, the UE 702 may be configured to concurrently perform bistatic sensing (e.g., at 710) in association with the monostatic sensing (e.g., at 710) performed by the base station 704.

The flow diagram 740 may represent the base station 704 configuring sensing aspects of the UE 702 based on a BWP switch during sensing operations. For instance, the UE 702 and/or the base station 704 may be configured to measure (at 712) first sensing measurement data associated with a sensing target(s) for a first sensing operation according to the number of layers in a first BWP/resource (e.g., based on a prior layer configuration, not shown for brevity and illustrative clarity). In one configuration, the UE 702 may be configured by a layer configuration to perform first monostatic sensing (e.g., at 712) with a configured number of layers in a first sensing resource/BWP. In one configuration, the UE 702 may be configured by the layer configuration 708 to perform first bistatic sensing (e.g., at 712) with a configured number of layers in a first sensing resource/BWP, and the base station 704 may concurrently perform first monostatic sensing (at 712) in association with the first bistatic sensing (e.g., at 712) performed by the UE 702. In another configuration, the base station 704 may be configured to perform first monostatic sensing (e.g., at 712) with a configured number of layers in a first sensing resource/BWP, and the UE 702 may be configured to concurrently perform first bistatic sensing (e.g., at 712) in association with the first monostatic sensing (e.g., at 712) that is performed by the base station 704.

The base station 704 may be configured to provide/transmit a BWP switch indication 714 to be received by the UE 702. In aspects, the BWP switch indication 714 may be associated with operational condition(s) associated with the UE 702, as described herein. Subsequent to the BWP switch indication 714, the base station 704 may be configured to provide/transmit a layer configuration 716 to be received by the UE 702. The layer configuration 716 may be a MIMO sensing configuration and may enable the base station 704 to configure the UE 70 with a set of layer parameters for MIMO JCS operations. In aspects, the set of layer parameters may indicate a number(s) of layers for sensing operations for one or more sensing resources (e.g., a second BWP(s) corresponding to the BWP switch indication 714).

The UE 702 and/or the base station 704 may be configured to measure (at 718) second sensing measurement data associated with the sensing target(s), or with another sensing target(s) in aspects, for a second sensing operation according to a number of layers in the second BWP/resource (e.g., based on the layer configuration 716). In one configuration, the UE 702 may be configured by the layer configuration 716 to perform second monostatic sensing (e.g., at 718) with a configured number of layers in a second sensing resource/BWP. In one configuration, the UE 702 may be configured by the layer configuration 716 to perform second bistatic sensing (e.g., at 718) with a configured number of layers in the second sensing resource/BWP, and the base station 704 may concurrently perform second monostatic sensing (e.g., at 718) in association with the second bistatic sensing performed by the UE 702 (e.g., at 718). In another configuration, the base station 704 may be configured to perform second monostatic sensing (e.g., at 718) with a configured number of layers in the second sensing resource/BWP, and the UE 702 may be configured to concurrently perform second bistatic sensing (e.g., at 718) in association with the second monostatic sensing (e.g., at 718) performed by the base station 704.

The flow diagram 750 may represent the base station 704 configuring sensing aspects of the UE 702 based on a switch from monostatic sensing to bistatic sensing during sensing operations. For instance, the UE 702 may be configured to measure (at 720) first sensing measurement data associated with a sensing target(s) for a first monostatic sensing operation according to the number of layers in a first BWP/resource (e.g., based on a prior layer configuration, not shown for brevity and illustrative clarity). The base station 704 may be configured to concurrently perform first bistatic sensing in association with the first monostatic sensing (e.g., at 720) performed by the UE 702.

The base station 704 may be configured to provide/transmit a layer configuration 722 to be received by the UE 702. The layer configuration 722 may be a MIMO sensing configuration and may enable the base station 704 to configure the UE 70 with a set of layer parameters for MIMO JCS operations. In aspects, the set of layer parameters may indicate a number(s) of layers for sensing operations for one or more sensing resources (e.g., a second BWP(s)).

The UE 702 and/or the base station 704 may be configured to measure (at 724) second sensing measurement data associated with the sensing target(s), or with another sensing target(s) in aspects, for a second sensing operation according to a number of layers in the second BWP/resource (e.g., based on the layer configuration 722). In one configuration, the UE 702 may be configured by the layer configuration 722 to perform second bistatic sensing (e.g., at 724) with a configured number of layers in the second sensing resource/BWP, and the base station 704 may concurrently perform second monostatic sensing (e.g., at 724) in association with the second bistatic sensing performed by the UE 702 (e.g., at 724).

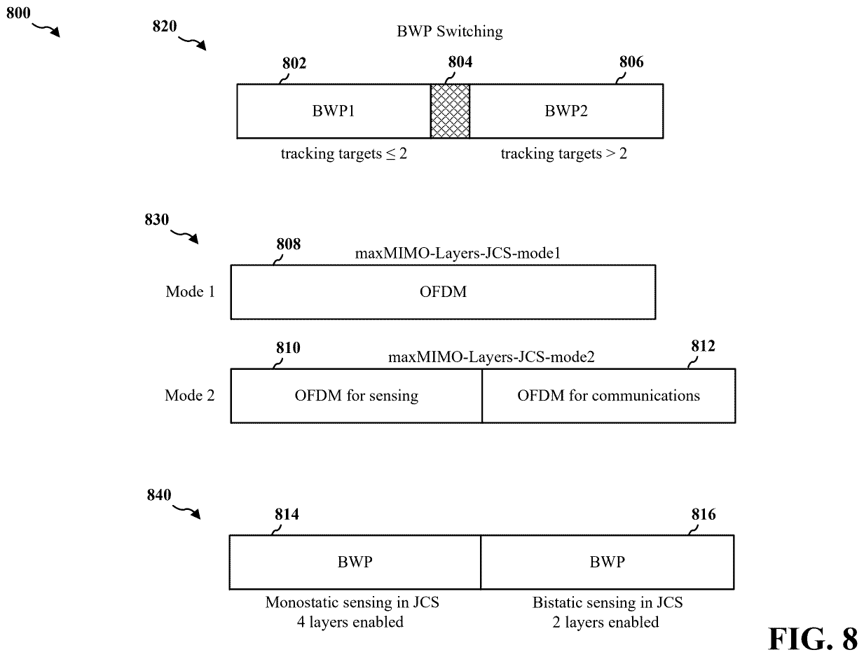

FIG. 8 is a diagram 800 illustrating example modes and BWPs in JCS, in accordance with various aspects of the present disclosure. Diagram 800 illustrates a configuration 820, a configuration 830, and a configuration 840, which may be aspects for maximum layer configurations to adapt JCS multi-layer interferences. As previously discussed, aspects may provide for a UE receive configuration elements via RRC signaling, and may utilize the element “maxMIMO-Layers-JCS” to configure the number of layers per a given cell, BWP (e.g., PRB), etc., for a data tone such as a PDSCH. Aspects may provide for different modes within the “maxMIMO-Layers-JCS” element for shared or individual communication and sensing resource (e.g., via “maxMIMO-Layers-JCS-mode1” and “maxMIMO-Layers-JCS-mode2”), and may also provide configurations for numbers of layers based on the type of the sensing operations, e.g., mono-/bi-static sensing.

The configuration 820 may be illustrative of BWP switching, as described herein. The configuration 820 shows a first BWP 802 (“BWP1”) and a second BWP 806 (“BWP2”) separated by a switching delay 804, or gap, that represents a time taken by a UE and/or a base station to switch from the first BWP 802 to the second BWP 806. In the context of bistatic sensing, a base station may configure two separate “maxMIMO-Layers-JCS” values for the two BWPs, e.g., a number of layers “2” to track up to two targets for the first BWP 802 and a number of layers greater than “2” to track more than two targets for the second BWP 806. As one example, a low tier UE may access the first BWP 802 for multi-layer JCS, and a premium or high tier UE (e.g., with additional capabilities beyond the low tier UE) may access the second BWP 806 for the multi-layer JCS as the premium UE may be able to better process/handle inter-layer interference. As another example, for motion tracking in the sensing, a UE may access the first BWP 802 to pursue high resolution/accuracy in sensing as less inter-layer interference impacts the sensing performance. As yet another example, a UE may be configured with multiple BWPs, and the UE may be configured to switch from the first BWP 802 to the second BWP 806, e.g., when the traffic burden is reduced and/or when more targets are detected. As an additional example, a UE may be in a scenario where tracking more targets in the sensing is desired, and the UE may be configured to switch from the first BWP 802 to the second BWP 806, e.g., when one layer is associated with one beam to track one target.

The configuration 830 may be illustrative of different modes within the “maxMIMO-Layers-JCS” element for shared or individual communication and sensing resource (e.g., via “maxMIMO-Layers-JCS-mode1” and “maxMIMO-Layers-JCS-mode2”). The configuration 830 shows a first mode (“mode 1) with an OFDM resource 808, and shows a second mode (“mode 2”) with an OFDM resource 810 for sensing and an OFDM resource 812 for communications.

In the context of JCS, in one aspect, a first configuration (e.g., “mode 1”) may be utilized in which a single waveform in one resource, e.g., for OFDM, may be used for both sensing and communications. In another aspect, a second configuration (e.g., “mode 2”) may be utilized in which a first resource may be for communications, and a second resource may be for sensing. In various aspects, the first and second resources may be associated with a single waveform, or with two waveforms, for both resources.

In aspects, for MIMO multi-layer in JCS, the element “maxMIMO-Layers-JCS,” which may be provided/transmitted to a UE via RRC signaling, may be defined for “mode 1” and for “mode 2.” For “mode 1,” the element “maxMIMO-Layers-JCS-mode1” may be utilized, and for “mode 2,” the element “maxMIMO-Layers-JCS-mode2” may be utilized, where such values may be configured for sensing resources in JCS. In aspects, the “maxMIMO-Layers-JCS-mode2” element may enable a more relaxed mode than the “maxMIMO-Layers-JCS-mode1” element, as such corresponding resources in JCS is may be for sensing or communications.

The configuration 840 may be illustrative of numbers of layers in BWPs for monostatic and bistatic sensing. The configuration 840 shows a BWP 814 and a BWP 816. The BWP 814 may be configured for monostatic sensing in JCS and may include four enabled layers, by way of example. The BWP 816 may be configured for bistatic sensing in JCS and may include two enabled layers, by way of example.

In aspects, for MIMO multi-layer in JCS, in one specific cell and BWP, there may be two values for elements included in “maxMIMO-Layers-JCS” provided/transmitted for a UE via RRC signaling, which may be separately configured for monostatic sensing and bistatic sensing. These two elements may be defined as “{maxMIMO-Layers-sensing-mono, maxMIMO-Layers-sensing-bi}” in RRC signaling. In aspects, monostatic sensing may be without the element “maxMIMO-layers-JCS.” Further, as noted for monostatic sensing, a base station or a UE may already be aware of what signal is transmitted on each layer, and the implementation complexity may be relatively low with relatively small inter-layer interference. Accordingly, in aspects, with a same configuration and key performance indicators (KPI), “maxMIMO-Layers-sensing-mono” may be larger than “maxMIMO-Layers-sensing-bi,” or the mono-static sensing may be unconstrained during sensing operations.

For example, and with continuing reference to configuration 840, in one cell, a UE may be configured with one BWP, and if the UE performs the monostatic sensing via the BWP 814 in JCS, the number of layers may be configured as less than “maxMIMO-Layers-sensing-mono.” Similarly, if the UE performs bistatic sensing via the BWP 816 with another base station or UE in the BWP 816, the number of layers may be configured as less than “maxMIMO-Layers-sensing-bi.” For instance, if “maxMIMO-Layers-sensing-mono” is configured with a value of 8 (“eight”), then “maxMIMO-Layers-sensing-bi” configured with a value of 2 (“two”). Thus, when the UE is enabled to switch its sensing from monostatic to bistatic, the enabled multi-layers may be 4 (“four”) to 2 (“two”) as illustrated in the configuration 840 for the BWP 814 and the BWP 816, respectively.

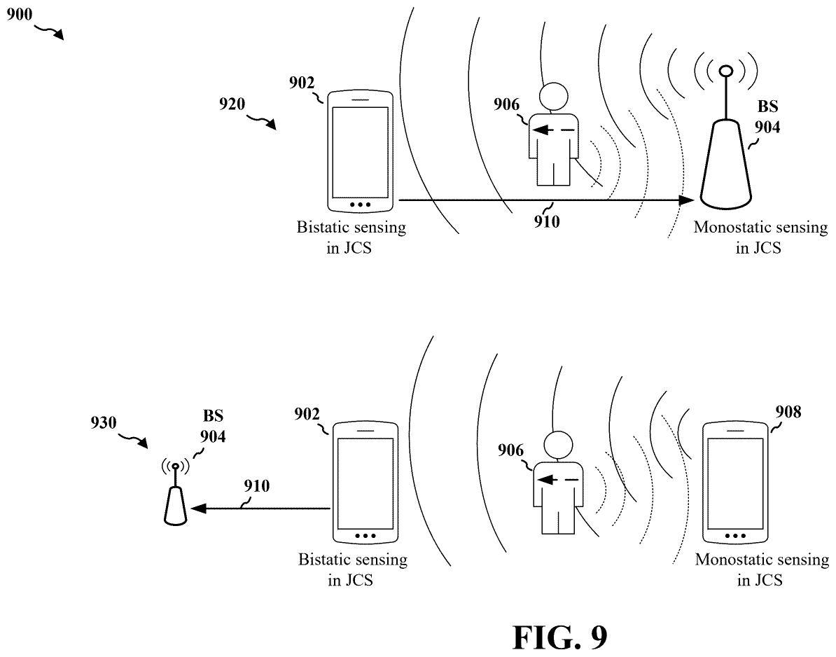

FIG. 9 is a diagram 900 illustrating example operations for JCS, in accordance with various aspects of the present disclosure. As noted herein, aspects may provide selection rules in configurations for simultaneously enabled mono-/bi-static sensing in a given resource, and may also provide for handling data transmission/sensing conflicts and reporting of UE capabilities for communications and/or sensing. Diagram 900 shows a configuration 920 and a configuration 930. In aspects, for JCS, when one resource (e.g., one BWP) is enabled simultaneously for monostatic and bistatic sensing, the maximum sensing layers may be configured as the minimum of the number of layers for monostatic sensing and the number of layers for bistatic sensing, e.g., “min {maxMIMO-Layers-sensing-mono, maxMIMO-Layers-sensing-bi},” or may be configured as “maxMIMO-Layers-sensing-bi,” and “maxMIMO-Layers-sensing-bi” may be less than “maxMIMO-Layers-sensing-mono.”

For example, in the configuration 920, a UE 902 may perform bistatic sensing for JCS on a target 906 (which may be in motion) with a base station 904. The base station 904 may transmit JCS signals to the UE 902, and the receiver of the UE 902 may estimate the target 906, while the base station 904 may also detect the target 906 in the echo of the transmitted JCS signals. In order to ensure the both of the base station 904 and the UE 902 are enabled to detect the target 906, the enabled number of layers may be configured as less than the value of “maxMIMO-Layers-sensing-bi.”

In the configuration 930, the UE 902 may perform bistatic sensing for JCS on the target 906 (which may be in motion) with a UE 908. In aspects, the UE 908 may be a low tier UE and the UE 902 may be a premium/high tier UE with additional capabilities beyond the low tier UE (e.g., the UE 908). In some cases, the value of “maxMIMO-Layers-sensing-bi” may not be less than the value of “maxMIMO-Layers-sensing-mono,” e.g., is greater than or equal to the value. In such cases, aspects herein provide for the receiving node (e.g., the UE 902 in the configuration 930) in bistatic sensing may be premium or high tier, with additional capabilities beyond the low tier UE, and may be configured to utilize the higher value of “maxMIMO-Layers-sensing-bi” as the UE 902 may be able to better process/handle inter-layer interference.

In aspects, and with reference to the configuration 920 and to the configuration 930, the UE 902 may be configured to report, to the base station 904, conflict information 910 that may be associated with the UE 902 having a MIMO configuration for a resource that indicates a maximum number of layers for both of sensing and data transmission, where the conflict information 910 may include the number of layers configured for/selected by the UE 902, e.g., for each PRB in a given cell, a first maximum number of layers for bistatic sensing, and/or a second maximum number of layers for monostatic sensing. The conflict information 910 may be reported by the UE 902 as UAI via MAC-CE and/or as UCI via a PUCCH.

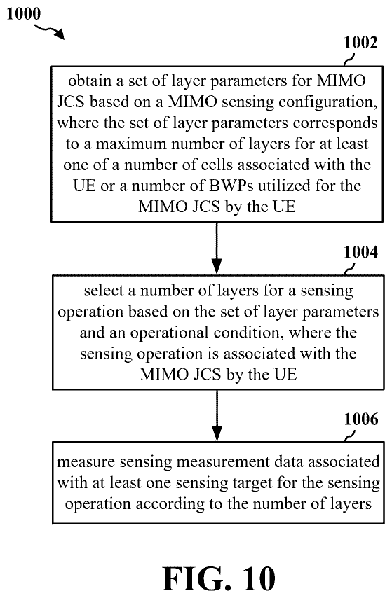

FIG. 10 is a flowchart 1000 of a method of wireless communication, in various aspects. The method may be performed by a UE (e.g., the UE 104, 404, 602, 702, 902, 908; the apparatus 1204). In some aspects, the method may include aspects described in connection with the communication flow in FIG. 6 and/or aspects described in FIGS. 7-9. The method provides for maximum layer configurations to adapt JCS multi-layer interferences that enables a UE to be configured by a network node (e.g., a base station) with layer parameters for maximum numbers of layers in sensing resources and cells based on operational conditions/capabilities of the UE, and to perform sensing efficiently, with accuracy, based on the sensing resources and layer parameters.

At 1002, the UE obtains a set of layer parameters for MIMO JCS based on a MIMO sensing configuration, where the set of layer parameters corresponds to a maximum number of layers for at least one of a number of cells associated with the UE or a number of BWPs utilized for the MIMO JCS by the UE 602. As an example, the obtaining may be performed by the component 198. FIGS. 6, 7 illustrate an example of the UE 602 obtaining such a set of layer parameters, for instance, from a network node (e.g., the base station 604).

The UE 602 may be configured to obtain (at 608) a set of layer parameters (e.g., based on the operational condition(s) 606; e.g., 708, 716, 722 in FIG. 7) for MIMO JCS based on a MIMO sensing configuration (e.g., 708, 716, 722 in FIG. 7), where the set of layer parameters (e.g., 708, 716, 722 in FIG. 7) corresponds to a maximum number of layers (e.g., 820, 830, 840 in FIG. 8) for at least one of a number of cells associated with the UE or a number of BWPs (e.g., 802, 806, 808, 810, 812, 814, 816 in FIG. 8) utilized for the MIMO JCS by the UE 602. In aspects, the set of layer parameters (e.g., 708, 716, 722 in FIG. 7) may be received by the UE 602 from the base station 604, e.g., based on the operational condition(s) 606 of the UE 602, which may include the UE capability (e.g., 706 in FIG. 7) of the UE 602. In some aspects, the UE capability (e.g., as included in the operational condition(s) 606 (e.g., 706 in FIG. 7)) associated with the MIMO JCS of the UE 602 may indicate a maximum layers (e.g., 820, 830, 840 in FIG. 8) supported for sensing, a maximum layers (e.g., 820, 830, 840 in FIG. 8) supported for mono-/bi-static sensing, a lack of the UE capability (e.g., 706 in FIG. 7) to support multiple layers (e.g., 820, 830, 840 in FIG. 8) in JCS, and/or the maximum number of layers (e.g., 820, 830, 840 in FIG. 8) for each of the number of cells associated with the UE or the number of BWPs (e.g., 802, 806, 808, 810, 812, 814, 816 in FIG. 8). In aspects, where a lack of support is indicated by the UE capability (e.g., 706 in FIG. 7), the maximum number of layers (e.g., 820, 830, 840 in FIG. 8) utilized for the MIMO JCS by the UE 602 may be configured/selected as a single layer.

At 1004, the UE selects a number of layers for a sensing operation based on the set of layer parameters and an operational condition, where the sensing operation is associated with the MIMO JCS by the UE 602. As an example, the selection may be performed by the component 198. FIGS. 6, 7 illustrate an example of the UE 602 performing such a selection, for instance, based on the layer parameters provided from a network node (e.g., the base station 604).

The UE 602 may be configured to select (at 610) a number of layers (e.g., 820, 830, 840 in FIG. 8) for a sensing operation (e.g., at 612, below; 710, 712, 718, 720, 724 in FIG. 7; 920, 930 in FIG. 9) based on the set of layer parameters and an operational condition (e.g., as included in the operational condition(s) 606; 708, 716, 722 in FIG. 7), where the sensing operation (e.g., at 612, below; 710, 712, 718, 720, 724 in FIG. 7; 920, 930 in FIG. 9) is associated with the MIMO JCS by the UE 602. For instance, the UE 602 may be configured to select (at 610) a number of layers (e.g., 820, 830, 840 in FIG. 8) from the set of layers for the sensing operation (e.g., at 612, below; 710, 712, 718, 720, 724 in FIG. 7; 920, 930 in FIG. 9) based at least in part on the operational condition(s) 606. In aspects, the UE 602 may be configured to select (at 610) a number of layers (e.g., 820, 830, 840 in FIG. 8) that may correspond to the number of sensing targets (e.g., 906 in FIG. 9) for the sensing operation (e.g., at 612, below; 710, 712, 718, 720, 724 in FIG. 7; 920, 930 in FIG. 9). In aspects, the UE 602 may be configured to select (at 610) the number of layers (e.g., 820, 830, 840 in FIG. 8) for the sensing operation (e.g., at 612, below; 710, 712, 718, 720, 724 in FIG. 7; 920, 930 in FIG. 9) as a minimum of the first maximum number of layers (e.g., 820, 830, 840 in FIG. 8) and the second maximum number of layers (e.g., 820, 830, 840 in FIG. 8), as the second maximum number of layers (e.g., 820, 830, 840 in FIG. 8) based on a UE capability (e.g., 706 in FIG. 7) of the UE 602. In such aspects, the UE 602 may be configured to report, to the base station 604, conflict information, e.g., included in the operational condition(s) (606) (e.g., 910 in FIG. 9) that may be associated with the UE 602 having a MIMO configuration (e.g., 708, 716, 722 in FIG. 7) for a resource (e.g., 802, 806, 808, 810, 812, 814, 816 in FIG. 8) that indicates a maximum number of layers (e.g., 820, 830, 840 in FIG. 8) for both of sensing and data transmission, where the conflict information (e.g., 910 in FIG. 9) may include the number of layers selected (at 610) by the UE 602, e.g., for each PRB in a given cell, the first maximum number of layers (e.g., 820, 830, 840 in FIG. 8), and/or the second maximum number of layers (e.g., 820, 830, 840 in FIG. 8). The conflict information (e.g., 910 in FIG. 9) may be reported by the UE 602 as UAI via a MAC-CE and/or as UCI via a PUCCH. In some aspects, in the absence of a configuration (e.g., 708, 716, 722 in FIG. 7) for a maximum number of layers (e.g., 820, 830, 840 in FIG. 8) for sensing, the UE 602 may be configured to select (at 610) a number of layers (e.g., 820, 830, 840 in FIG. 8) that is specified for transmissions of data. In some aspects, the UE 602 may be configured to select (at 610) the set of layer parameters (e.g., 708, 716, 722 in FIG. 7) from a list of layer parameters.

At 1006, the UE measures sensing measurement data associated with at least one sensing target for the sensing operation according to the number of layers. As an example, the measurement may be performed by the component 198. FIGS. 6, 7 illustrate an example of the UE 602 performing such a measurement, for instance, with or without a network node (e.g., the base station 604).

The UE 602 may be configured to measure (at 612) (e.g., 710, 712, 718, 720, 724 in FIG. 7; 920, 930 in FIG. 9) sensing measurement data associated with at least one sensing target (e.g., 906 in FIG. 9) for the sensing operation (e.g., at 612, below; 710, 712, 718, 720, 724 in FIG. 7; 920, 930 in FIG. 9) according to the number of layers (e.g., 820, 830, 840 in FIG. 8). In aspects, the UE 602 may be further configured to measure (at 612) (e.g., 710, 712, 718, 720, 724 in FIG. 7; 920, 930 in FIG. 9) other sensing measurement data associated with at least one other sensing target (e.g., 906 in FIG. 9) for at least one other sensing operation (e.g., 712, 720 in FIG. 7) prior to obtaining the set of layer parameters (e.g., 708, 716, 722 in FIG. 7) for the MIMO JCS. In such aspects, the UE 602 may be configured to measure (at 612) (e.g., 710, 712, 718, 720, 724 in FIG. 7; 920, 930 in FIG. 9) the sensing measurement data based on the MIMO sensing configuration (e.g., 708, 716, 722 in FIG. 7), with at least one of a different BWP (e.g., 802, 806, 808, 810, 812, 814, 816 in FIG. 8) or a different sensing operation type compared to measuring the other sensing measurement data associated with the at least one other sensing target (e.g., 906 in FIG. 9) for the at least one other sensing operation (e.g., 712, 720 in FIG. 7). In aspects, the UE 602 may be configured to perform monostatic sensing (at 612) (e.g., 710, 720 in FIG. 7) without the base station 604, to perform monostatic sensing (at 612) (e.g., 710, 720 in FIG. 7) with the base station 604, and/or to perform bistatic sensing (at 612) (e.g., 710, 712, 718, 724 in FIG. 7; 920, in FIG. 9) in conjunction with the base station 604 and/or with an additional UE (e.g., 908 in FIG. 9) or sensing node (e.g., 930 in FIG. 9).

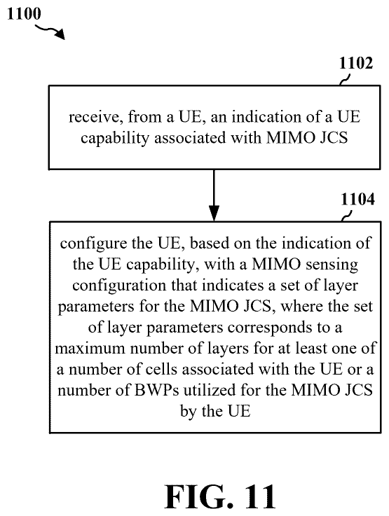

FIG. 11 is a flowchart 1100 of a method of wireless communication, in various aspects. The method may be performed by a base station (e.g., the base station 102, 604, 704, 904; the network entity 1202, 1302). In some aspects, the method may include aspects described in connection with the communication flow in FIG. 6 and/or aspects described in FIGS. 7-9. The method provides for maximum layer configurations to adapt JCS multi-layer interferences that enables a UE to be configured by a network node (e.g., a base station) with layer parameters for maximum numbers of layers in sensing resources and cells based on operational conditions/capabilities of the UE, and to perform sensing efficiently, with accuracy, based on the sensing resources and layer parameters.

At 1102, the base station receives, from a UE, an indication of a UE capability associated with MIMO JCS. As an example, the reception may be performed by the component 199. FIGS. 6, 7 illustrate an example such a reception by the base station 604 for an indication of UE capability (e.g., of the UE 602).

The base station 604 may be configured to receive, as provided/transmitted by the UE 602, an operational condition(s) 606 associated with the UE 602. For instance, the UE 602 may be configured to provide/transmit to be received by the base station 604 the operational condition(s) 606 that include, without limitation, an amount of sensing resolution, an amount of sensing accuracy, a UE capability (e.g., 706 in FIG. 7) of the UE 602 (e.g., including a UE capability of the UE 602 associated with the MIMO JCS), a number of sensing targets (e.g., 906 in FIG. 9), a traffic burden, and/or the like. In some aspects, the UE capability (e.g., 706 in FIG. 7) (e.g., as included in the operational condition(s) 606) associated with the MIMO JCS of the UE 602 may indicate support for, or a lack of the UE capability (e.g., 706 in FIG. 7) to support, multiple layers (e.g., 820, 830, 840 in FIG. 8) in JCS. The UE 602 may be configured to report its maximum support layers (e.g., 820, 830, 840 in FIG. 8) for sensing, or its maximum supported layers (e.g., 820, 830, 840 in FIG. 8) for monostatic sensing and maximum supported layers (e.g., 820, 830, 840 in FIG. 8) for bi-static sensing (e.g., as in 606).

At 1104, the base station configures the UE, based on the indication of the UE capability, with a MIMO sensing configuration that indicates a set of layer parameters for the MIMO JCS, where the set of layer parameters corresponds to a maximum number of layers for at least one of a number of cells associated with the UE or a number of BWPs utilized for the MIMO JCS by the UE. As an example, the configuration may be performed by the component 199. FIGS. 6, 7 illustrate an example of the base station 604 performing such a configuration for a UE (e.g., the UE 602).

The UE 602 may be configured to obtain (at 608) a set of layer parameters (e.g., based on the operational condition(s) 606; e.g., 708, 716, 722 in FIG. 7) for MIMO JCS based on a MIMO sensing configuration (e.g., 708, 716, 722 in FIG. 7), where the set of layer parameters (e.g., 708, 716, 722 in FIG. 7) corresponds to a maximum number of layers (e.g., 820, 830, 840 in FIG. 8) for at least one of a number of cells associated with the UE or a number of BWPs (e.g., 802, 806, 808, 810, 812, 814, 816 in FIG. 8) utilized for the MIMO JCS by the UE 602 for sensing operations (e.g., 710, 712, 718, 720, 724 in FIG. 7; 920, 930 in FIG. 9). In aspects, the set of layer parameters (e.g., 708, 716, 722 in FIG. 7) may be received by the UE 602 from the base station 604, e.g., based on the operational condition(s) 606 of the UE 602, which may include the UE capability (e.g., 706 in FIG. 7) of the UE 602. In some aspects, the UE capability (e.g., 706 in FIG. 7) (e.g., as included in the operational condition(s) 606) associated with the MIMO JCS of the UE 602 may indicate a maximum layers (e.g., 820, 830, 840 in FIG. 8) supported for sensing, a maximum layers (e.g., 820, 830, 840 in FIG. 8) supported for mono-/bi-static sensing, a lack of the UE capability to support multiple layers (e.g., 820, 830, 840 in FIG. 8) in JCS, and/or the maximum number of layers (e.g., 820, 830, 840 in FIG. 8) for each of the number of cells associated with the UE or the number of BWPs (e.g., 802, 806, 808, 810, 812, 814, 816 in FIG. 8). In aspects, where a lack of support is indicated by the UE capability (e.g., 706 in FIG. 7), the maximum number of layers (e.g., 820, 830, 840 in FIG. 8) utilized for the MIMO JCS by the UE 602 may be configured/selected as a single layer.

Accordingly, the base station 604 may configure the UE 602 via a MIMO sensing configuration that may include, without limitation, the set of layer parameters (e.g., 708, 716, 722 in FIG. 7).

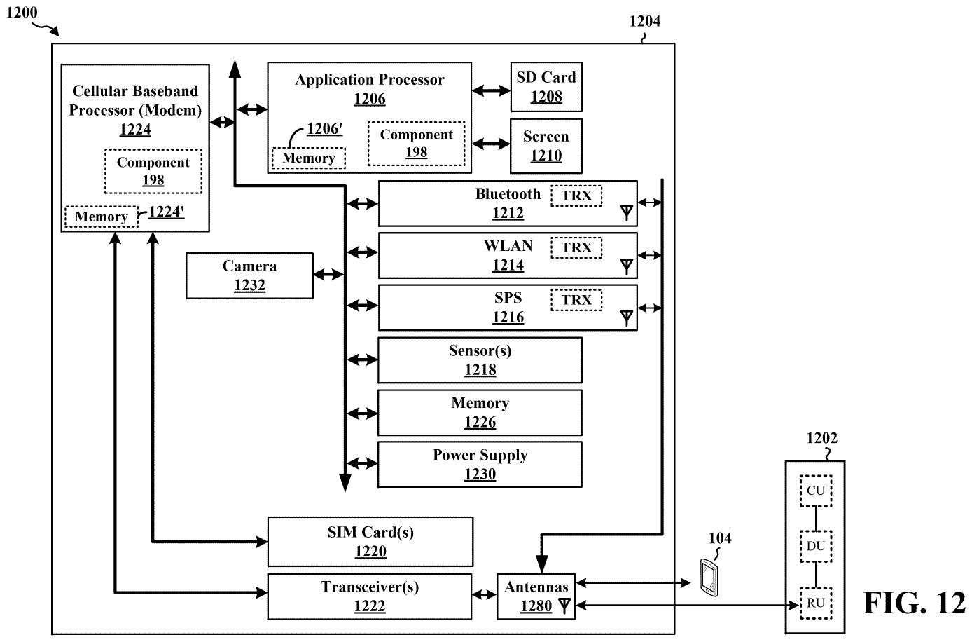

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see UE 350 of FIG. 3) and include the additional modules of the apparatus 1204.

As discussed supra, the component 198 may be configured to obtain a set of layer parameters for multiple-input multiple-output (MIMO) joint communication and sensing (JCS) based on a MIMO sensing configuration, where the set of layer parameters corresponds to a maximum number of layers for at least one of a number of cells associated with a user equipment (UE) or a number of bandwidth parts (BWPs) utilized for the MIMO JCS by the UE. The component 198 may also be configured to select a number of layers for a sensing operation based on the set of layer parameters and an operational condition, where the sensing operation is associated with the MIMO JCS by the UE. The component 198 may be further configured to measure sensing measurement data associated with at least one sensing target for the sensing operation according to the number of layers. The component 198 may be configured to operate in a first BWP of the number of BWPs according to at least one of: the UE capability of the UE, at least one of the amount of the sensing resolution or the amount of the sensing accuracy for motion tracking in the first BWP, or the number of sensing targets for the sensing operation, where to operate in the first BWP of the number of BWPs, the component 198 may be configured to switch from a second BWP of the number of BWPs to the first BWP, and where the number of layers that is selected corresponds to the number of sensing targets for the sensing operation. The component 198 may be configured to transmit, for a network node, a conflict indication associated with the first maximum number of layers and the second maximum number of layers through at least one of UE assistance information (UAI) via a medium access control (MAC) control element (MAC-CE) or uplink control information (UCI) via a physical uplink control channel (PUCCH). The component 198 may be configured to transmit, for a network node, an indication of a UE capability of the UE associated with the MIMO JCS, where to obtain the set of layer parameters for the MIMO JCS, the component 198 may be configured to: receive, from the network node, the set of layer parameters based on the UE capability. The component 198 may be configured to measure other sensing measurement data associated with at least one other sensing target for at least one other sensing operation prior to obtaining the set of layer parameters for the MIMO JCS, where to measure the sensing measurement data, the component 198 may be configured to measure the sensing measurement data, based on the MIMO sensing configuration, with at least one of a different BWP or a different sensing operation type compared to measuring the other sensing measurement data associated with the at least one other sensing target for the at least one other sensing operation. The component 198 may be further configured to perform any of the aspects described in connection with the flowchart in any of FIGS. 10, 11, and/or any of the aspects performed by a UE in association with any of FIGS. 5-9. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, may include means for obtaining a set of layer parameters for multiple-input multiple-output (MIMO) joint communication and sensing (JCS) based on a MIMO sensing configuration, where the set of layer parameters corresponds to a maximum number of layers for at least one of a number of cells associated with a user equipment (UE) or a number of bandwidth parts (BWPs) utilized for the MIMO JCS by the UE. In the configuration, the apparatus 1204, and in particular the cellular baseband processor 1224 and/or the application processor 1206, may include means for selecting a number of layers for a sensing operation based on the set of layer parameters and an operational condition, where the sensing operation is associated with the MIMO JCS by the UE. In the configuration, the apparatus 1204, and in particular the cellular baseband processor 1224 and/or the application processor 1206, may include means for measuring sensing measurement data associated with at least one sensing target for the sensing operation according to the number of layers. In one configuration, the apparatus 1204, and in particular the cellular baseband processor 1224 and/or the application processor 1206, may include means for operating in a first BWP of the number of BWPs according to at least one of: the UE capability of the UE, at least one of the amount of the sensing resolution or the amount of the sensing accuracy for motion tracking in the first BWP, or the number of sensing targets for the sensing operation, where for operating in the first BWP of the number of BWPs, the apparatus 1204, and in particular the cellular baseband processor 1224 and/or the application processor 1206, may include means for switching from a second BWP of the number of BWPs to the first BWP, and where the number of layers that is selected corresponds to the number of sensing targets for the sensing operation. In one configuration, the apparatus 1204, and in particular the cellular baseband processor 1224 and/or the application processor 1206, may include means for transmitting, for a network node, a conflict indication associated with the first maximum number of layers and the second maximum number of layers through at least one of UE assistance information (UAI) via a medium access control (MAC) control element (MAC-CE) or uplink control information (UCI) via a physical uplink control channel (PUCCH). In one configuration, the apparatus 1204, and in particular the cellular baseband processor 1224 and/or the application processor 1206, may include means for transmitting, for a network node, an indication of a UE capability of the UE associated with the MIMO JCS, where for obtaining the set of layer parameters for the MIMO JCS, the apparatus 1204, and in particular the cellular baseband processor 1224 and/or the application processor 1206, may include means for: receiving, from the network node, the set of layer parameters based on the UE capability. In one configuration, the apparatus 1204, and in particular the cellular baseband processor 1224 and/or the application processor 1206, may include means for measuring other sensing measurement data associated with at least one other sensing target for at least one other sensing operation prior to obtaining the set of layer parameters for the MIMO JCS, where for measuring the sensing measurement data, the apparatus 1204, and in particular the cellular baseband processor 1224 and/or the application processor 1206, may include means for measuring the sensing measurement data, based on the MIMO sensing configuration, with at least one of a different BWP or a different sensing operation type compared to measuring the other sensing measurement data associated with the at least one other sensing target for the at least one other sensing operation. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

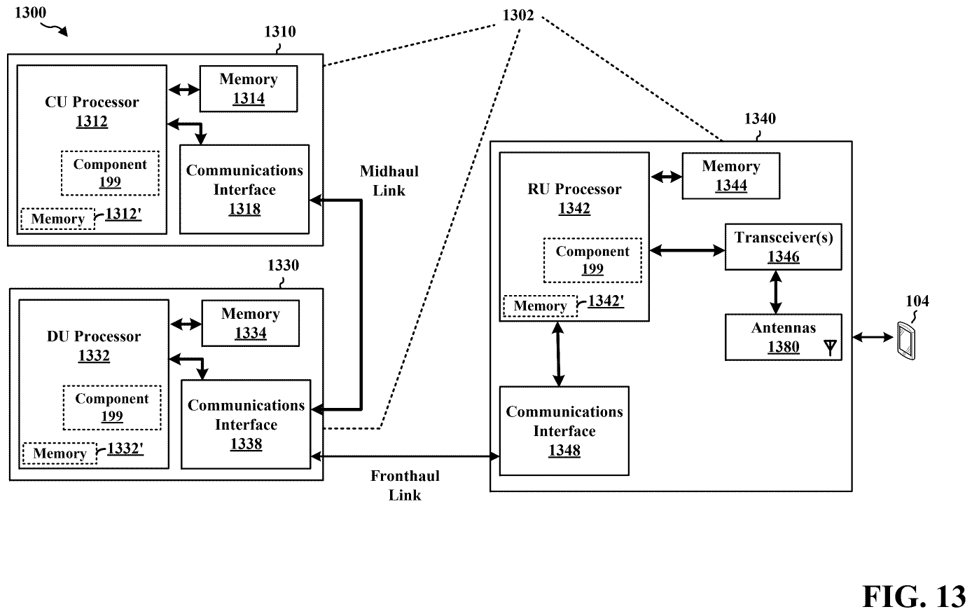

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE, an indication of a UE capability associated with MIMO JCS. The component 199 may also be configured to configure the UE, based on the indication of the UE capability, with a MIMO sensing configuration that indicates a set of layer parameters for the MIMO JCS, where the set of layer parameters corresponds to a maximum number of layers for at least one of a number of cells associated with the UE or a number of BWPs utilized for the MIMO JCS by the UE. The component 199 may be configured to receive, from the UE, a conflict indication associated with the first maximum number of layers and the second maximum number of layers through at least one of UAI via MAC-CE or UCI via a physical uplink control channel PUCCH. The component 199 may be configured to select a number of layers for a sensing operation based on at least one of the set of layer parameters or an operational condition of the UE associated with the indication of the UE capability, where the sensing operation is associated with the MIMO JCS. The component 199 may be configured to measure sensing measurement data associated with at least one sensing target for the sensing operation according to the number of layers. The component 199 may be configured to operate in a first BWP of the number of BWPs according to at least one of: the UE capability of the UE, at least one of the amount of the sensing resolution or the amount of the sensing accuracy for motion tracking in the first BWP, or the number of sensing targets for the sensing operation, where to operate in the first BWP of the number of BWPs, the component 199 may be configured to switch from a second BWP of the number of BWPs to the first BWP, and where the number of layers that is selected corresponds to the number of sensing targets for the sensing operation. The component 199 may be configured to measure other sensing measurement data associated with at least one other sensing target for at least one other sensing operation prior to configuring the UE with the MIMO sensing configuration, where to measure the sensing measurement data, the component 199 may be configured to measure the sensing measurement data, based on the indication of the UE capability, with at least one of a different BWP or a different sensing operation type compared to measuring the other sensing measurement data associated with the at least one other sensing target for the at least one other sensing operation. The component 199 may be further configured to perform any of the aspects described in connection with the flowchart in any of FIGS. 10, 11, and/or any of the aspects performed by a base station in association with any of FIGS. 5-9. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 may include means for receiving, from a UE, an indication of a UE capability associated with MIMO JCS. In the configuration, the network entity 1302 may include means for configuring the UE, based on the indication of the UE capability, with a MIMO sensing configuration that indicates a set of layer parameters for the MIMO JCS, where the set of layer parameters corresponds to a maximum number of layers for at least one of a number of cells associated with the UE or a number of BWPs utilized for the MIMO JCS by the UE. In one configuration, the network entity 1302 may include means for receiving, from the UE, a conflict indication associated with the first maximum number of layers and the second maximum number of layers through at least one of UAI via MAC-CE or UCI via a physical uplink control channel PUCCH. In one configuration, the network entity 1302 may include means for selecting a number of layers for a sensing operation based on at least one of the set of layer parameters or an operational condition of the UE associated with the indication of the UE capability, where the sensing operation is associated with the MIMO JCS. In one configuration, the network entity 1302 may include means for measuring sensing measurement data associated with at least one sensing target for the sensing operation according to the number of layers. In one configuration, the network entity 1302 may include means for operating in a first BWP of the number of BWPs according to at least one of: the UE capability of the UE, at least one of the amount of the sensing resolution or the amount of the sensing accuracy for motion tracking in the first BWP, or the number of sensing targets for the sensing operation, where for operating in the first BWP of the number of BWPs, the network entity 1302 may include means for switching from a second BWP of the number of BWPs to the first BWP, and where the number of layers that is selected corresponds to the number of sensing targets for the sensing operation. In one configuration, the network entity 1302 may include means for measuring other sensing measurement data associated with at least one other sensing target for at least one other sensing operation prior to configuring the UE with the MIMO sensing configuration, where for measuring the sensing measurement data, the network entity 1302 may include means for measuring the sensing measurement data, based on the indication of the UE capability, with at least one of a different BWP or a different sensing operation type compared to measuring the other sensing measurement data associated with the at least one other sensing target for the at least one other sensing operation. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

Wireless communication networks, wireless devices on the wireless communication network, and/or the like, may utilize JCS operations for communications and sensing. Configuring multiple layers for communication operations may increase information throughput, such as for data and control information (e.g., in MIMO operations: SU-MIMO and/or MU-MIMO). Similarly, signals transmitted via OFDM may include multiple layers. However, while configuring multiple layers for sensing operations may increase information throughput, it may also result in higher inter-layer interference therebetween and impact sensing performance (e.g., accuracy, etc.) due to the inter-layer interference being proportional to the number of layers in the sensing operations. The handling of inter-layer interference between layers may also impact the performance of wireless systems and wireless devices through increased complexity and time for inter-layer interference cancellation processing (e.g., impacts system and device efficiency/performance), and may also increase delays in signal transmissions.

The aspects described herein for maximum layer configurations to adapt JCS multi-layer interferences enable wireless network devices to more efficiently to accurately and efficiently perform multi-layer sensing for JCS through management of inter-layer interference. In one example, a UE may obtain a set of layer parameters for MIMO JCS based on a MIMO sensing configuration. The set of layer parameters may correspond to a maximum number of layers for at least one of a number of cells associated with the UE or a number of BWPs utilized for the MIMO JCS by the UE. The UE may also select a number of layers for a sensing operation based on the set of layer parameters and an operational condition, where the sensing operation is associated with the MIMO JCS by the UE, measure sensing measurement data associated with at least one sensing target for the sensing operation according to the number of layers. In another example, a network node (e.g., a base station) may receive, from a UE, an indication of a UE capability associated with MIMO JCS, and configure the UE, based on the indication of the UE capability, with a MIMO sensing configuration that indicates a set of layer parameters for the MIMO JCS. The set of layer parameters may correspond to a maximum number of layers for at least one of a number of cells associated with the UE or a number of BWPs utilized for the MIMO JCS by the UE.

In aspects described herein, by configuring a maximum number of layers for MIMO JCS sensing operations, the described techniques can be used to maintain sensing accuracy and performance while not overly increasing complexity for systems, devices, and/or operations. Relatedly, by basing the configurations for the maximum number of layers in MIMO JCS sensing operations on operational conditions of the wireless network/devices, the described techniques can be used to situationally and/or dynamically utilize a maximum number of layers with respect to types of sensing, specific cells, a BWP(s) used for sensing, and/or the like, while minimizing inter-layer interference between the layers.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is method of wireless communication at a user equipment (UE), including: obtaining a set of layer parameters for multiple-input multiple-output (MIMO) joint communication and sensing (JCS) based on a MIMO sensing configuration, where the set of layer parameters corresponds to a maximum number of layers for at least one of a number of cells associated with the UE or a number of bandwidth parts (BWPs) utilized for the MIMO JCS by the UE; selecting a number of layers for a sensing operation based on the set of layer parameters and an operational condition, where the sensing operation is associated with the MIMO JCS by the UE; and measuring sensing measurement data associated with at least one sensing target for the sensing operation according to the number of layers.

Aspect 2 is the method of aspect 1, where each of the number of BWPs utilized for the MIMO JCS by the UE is a physical resource block (PRB), where each PRB is configured by the MIMO sensing configuration via radio resource control (RRC) signaling, and where each PRB is configured by the MIMO sensing configuration with a respective layer parameter value for one or more layer parameters in the set of layer parameters.

Aspect 3 is the method of aspect 2, where the operational condition includes at least one of an amount of sensing resolution, an amount of sensing accuracy, a UE capability of the UE, a number of sensing targets, or a traffic burden; the method further including: operating in a first BWP of the number of BWPs according to at least one of: the UE capability of the UE, at least one of the amount of the sensing resolution or the amount of the sensing accuracy for motion tracking in the first BWP, or the number of sensing targets for the sensing operation, where operating in the first BWP of the number of BWPs includes switching from a second BWP of the number of BWPs to the first BWP, and where the number of layers that is selected corresponds to the number of sensing targets for the sensing operation.

Aspect 4 is the method of any of aspects 1 to 3, where the set of layer parameters is associated with (1) a single resource for communication operations and the sensing operation or (2) a first resource for the communication operations and a second resource for the sensing operation.

Aspect 5 is the method of aspect 4, where the set of layer parameters is associated with the single resource for the communication operations and the sensing operation, where the set of layer parameters includes a first layer parameter for a first maximum number of layers in the communication operations and a second layer parameter for a second maximum number of layers in the sensing operation, and where selecting the number of layers for the sensing operation includes selecting the number of layers for the sensing operation as a minimum of the first maximum number of layers and the second maximum number of layers.

Aspect 6 is the method of aspect 5, further including: transmitting, for a network node, a conflict indication associated with the first maximum number of layers and the second maximum number of layers through at least one of UE assistance information (UAI) via a medium access control (MAC) control element (MAC-CE) or uplink control information (UCI) via a physical uplink control channel (PUCCH).

Aspect 7 is the method of any of aspects 1 to 6, where the set of layer parameters corresponds to the maximum number of layers for a first cell of the number of cells associated with the UE and for a first BWP of the number of BWPs utilized for the MIMO JCS by the UE, and where the set of layer parameters includes a first layer parameter for a first maximum number of layers associated with monostatic sensing and a second layer parameter for a second maximum number of layers associated with bistatic sensing.

Aspect 8 is the method of aspect 7, where the first layer parameter for the first maximum number of layers associated with the monostatic sensing has a value that is higher than the second layer parameter for the second maximum number of layers associated with the bistatic sensing; or where the first layer parameter for the first maximum number of layers associated with the monostatic sensing is unconstrained during the sensing operation when the sensing operation is monostatic.

Aspect 9 is the method of any of aspects 1 to 8, where a BWP of the number of BWPs is configured for monostatic sensing and bistatic sensing, where the set of layer parameters includes a first layer parameter for a first maximum number of layers associated with the monostatic sensing and a second layer parameter for a second maximum number of layers associated with the bistatic sensing, and where selecting the number of layers for the sensing operation includes selecting the number of layers for the sensing operation as a minimum of the first maximum number of layers and the second maximum number of layers.

Aspect 10 is the method of any of aspects 1 to 8, where a BWP of the number of BWPs is configured for monostatic sensing and bistatic sensing, where the set of layer parameters includes a first layer parameter for a first maximum number of layers associated with the monostatic sensing and a second layer parameter for a second maximum number of layers associated with the bistatic sensing that is higher than the first maximum number of layers, and where selecting the number of layers for the sensing operation includes selecting the number of layers for the sensing operation as the second maximum number of layers based on a UE capability.

Aspect 11 is the method of any of aspects 1 to 10, further including: transmitting, for a network node, an indication of a UE capability of the UE associated with the MIMO JCS; where obtaining the set of layer parameters for the MIMO JCS includes: receiving, from the network node, the set of layer parameters based on the UE capability.

Aspect 12 is the method of aspect 11, where the indication of the UE capability associated with the MIMO JCS indicates a lack of the UE capability, and where the maximum number of layers for each of the number of cells associated with the UE or the number of BWPs utilized for the MIMO JCS by the UE is a single layer.

Aspect 13 is the method of any of aspects 1 to 12, where obtaining the set of layer parameters for the MIMO JCS includes: selecting the set of layer parameters from a list of layer parameters.

Aspect 14 is the method of any of aspects 1 to 13, further including: measuring other sensing measurement data associated with at least one other sensing target for at least one other sensing operation prior to obtaining the set of layer parameters for the MIMO JCS; where measuring the sensing measurement data includes measuring the sensing measurement data, based on the MIMO sensing configuration, with at least one of a different BWP or a different sensing operation type compared to measuring the other sensing measurement data associated with the at least one other sensing target for the at least one other sensing operation.

Aspect 15 is a method of wireless communication at a network node, including: receiving, from a user equipment (UE), an indication of a UE capability associated with multiple-input multiple-output (MIMO) joint communication and sensing (JCS); and configuring the UE, based on the indication of the UE capability, with a MIMO sensing configuration that indicates a set of layer parameters for the MIMO JCS, where the set of layer parameters corresponds to a maximum number of layers for at least one of a number of cells associated with the UE or a number of bandwidth parts (BWPs) utilized for the MIMO JCS by the UE.

Aspect 16 is the method of aspect 15, where each of the number of BWPs utilized for the MIMO JCS by the UE is a physical resource block (PRB), where each PRB is configured by the MIMO sensing configuration via radio resource control (RRC) signaling, and where each PRB is configured by the MIMO sensing configuration with a respective layer parameter value for one or more layer parameters in the set of layer parameters.

Aspect 17 is the method of any of aspects 15 and 16, where the set of layer parameters is associated with (1) a single resource for communication operations and a sensing operation or (2) a first resource for the communication operations and a second resource for the sensing operation.

Aspect 18 is the method of aspect 17, where the set of layer parameters is associated with the single resource for the communication operations and the sensing operation, where the set of layer parameters includes a first layer parameter for a first maximum number of layers in the communication operations and a second layer parameter for a second maximum number of layers in the sensing operation.

Aspect 19 is the method of aspect 18, further including: receiving, from the UE, a conflict indication associated with the first maximum number of layers and the second maximum number of layers through at least one of UE assistance information (UAI) via a medium access control (MAC) control element (MAC-CE) or uplink control information (UCI) via a physical uplink control channel (PUCCH).

Aspect 20 is the method of any of aspects 15 to 19, where the set of layer parameters corresponds to the maximum number of layers for a first cell of the number of cells associated with the UE and for a first BWP of the number of BWPs utilized for the MIMO JCS by the UE, and where the set of layer parameters includes a first layer parameter for a first maximum number of layers associated with monostatic sensing and a second layer parameter for a second maximum number of layers associated with bistatic sensing.

Aspect 21 is the method of aspect 20, where the first layer parameter for the first maximum number of layers associated with the monostatic sensing has a value that is higher than the second layer parameter for the second maximum number of layers associated with the bistatic sensing; or where the first layer parameter for the first maximum number of layers associated with the monostatic sensing is unconstrained for a sensing operation when the sensing operation is monostatic.

Aspect 22 is the method of any of aspects 15 to 21, where a BWP of the number of BWPs is configured for monostatic sensing and bistatic sensing by the MIMO sensing configuration, where the set of layer parameters includes a first layer parameter for a first maximum number of layers associated with the monostatic sensing and a second layer parameter for a second maximum number of layers associated with the bistatic sensing, and where a selection of a number of layers for a sensing operation includes the selection of the number of layers for the sensing operation as a minimum of the first maximum number of layers and the second maximum number of layers.

Aspect 23 is the method of any of aspects 15 to 21, where a BWP of the number of BWPs is configured for monostatic sensing and bistatic sensing, where the set of layer parameters includes a first layer parameter for a first maximum number of layers associated with the monostatic sensing and a second layer parameter for a second maximum number of layers associated with the bistatic sensing that is higher than the first maximum number of layers based on the UE capability.

Aspect 24 is the method of any of aspects 15 to 23, where the indication of the UE capability associated with the MIMO JCS indicates a lack of the UE capability, and where the maximum number of layers for each of the number of cells associated with the UE or the number of BWPs utilized for the MIMO JCS by the UE is a single layer.

Aspect 25 is the method of any of aspects 15 to 24, further including: selecting a number of layers for a sensing operation based on at least one of the set of layer parameters or an operational condition of the UE associated with the indication of the UE capability, where the sensing operation is associated with the MIMO JCS; and measuring sensing measurement data associated with at least one sensing target for the sensing operation according to the number of layers.

Aspect 26 is the method of aspect 25, where the operational condition of the UE includes at least one of an amount of sensing resolution, an amount of sensing accuracy, the UE capability, a number of sensing targets, or a traffic burden; the method further including: operating in a first BWP of the number of BWPs according to at least one of: the UE capability of the UE, at least one of the amount of the sensing resolution or the amount of the sensing accuracy for motion tracking in the first BWP, or the number of sensing targets for the sensing operation, where operating in the first BWP of the number of BWPs includes switching from a second BWP of the number of BWPs to the first BWP, and where the number of layers that is selected corresponds to the number of sensing targets for the sensing operation.

Aspect 26 is the method of aspect 25, further including: measuring other sensing measurement data associated with at least one other sensing target for at least one other sensing operation prior to configuring the UE with the MIMO sensing configuration; where measuring the sensing measurement data includes measuring the sensing measurement data, based on the indication of the UE capability, with at least one of a different BWP or a different sensing operation type compared to measuring the other sensing measurement data associated with the at least one other sensing target for the at least one other sensing operation.

Aspect 28 is an apparatus for wireless communication including means for implementing any of aspects 1 to 14.

Aspect 29 is a computer-readable medium (e.g., a non-transitory computer-readable medium) storing computer executable code, the code when executed by at least one processor causes the at least one processor to implement any of aspects 1 to 14.

Aspect 30 is an apparatus for wireless communication at a network node. The apparatus includes a memory; and at least one processor coupled to the memory and, based at least in part on information stored in the memory, the at least one processor is configured to implement any of aspects 1 to 14.

Aspect 31 is the apparatus of aspect 30, further including at least one of a transceiver or an antenna coupled to the at least one processor.

Aspect 32 is an apparatus for wireless communication including means for implementing any of aspects 15 to 28.

Aspect 33 is a computer-readable medium (e.g., a non-transitory computer-readable medium) storing computer executable code, the code when executed by at least one processor causes the at least one processor to implement any of aspects 15 to 28.

Aspect 34 is an apparatus for wireless communication at a network node. The apparatus includes a memory; and at least one processor coupled to the memory and, based at least in part on information stored in the memory, the at least one processor is configured to implement any of aspects 15 to 28.

Aspect 35 is the apparatus of aspect 34, further including at least one of a transceiver or an antenna coupled to the at least one processor.

1. An apparatus for wireless communication at a user equipment (UE), comprising:
a memory; and
at least one processor coupled to the memory and, based at least in part on information stored in the memory, the at least one processor is configured to:
obtain a set of layer parameters for multiple-input multiple-output (MIMO) joint communication and sensing (JCS) based on a MIMO sensing configuration, wherein the set of layer parameters corresponds to a maximum number of layers for at least one of a number of cells associated with the UE or a number of bandwidth parts (BWPs) utilized for the MIMO JCS by the UE;
select a number of layers for a sensing operation based on the set of layer parameters and an operational condition, wherein the sensing operation is associated with the MIMO JCS by the UE; and
measure sensing measurement data associated with at least one sensing target for the sensing operation according to the number of layers.

2. The apparatus of claim 1, wherein each of the number of BWPs utilized for the MIMO JCS by the UE is a physical resource block (PRB), wherein each PRB is configured by the MIMO sensing configuration via radio resource control (RRC) signaling, and wherein each PRB is configured by the MIMO sensing configuration with a respective layer parameter value for one or more layer parameters in the set of layer parameters.

3. The apparatus of claim 2, wherein the operational condition includes at least one of an amount of sensing resolution, an amount of sensing accuracy, a UE capability of the UE, a number of sensing targets, or a traffic burden;
wherein the at least one processor is further configured to:
operate in a first BWP of the number of BWPs according to at least one of:
the UE capability of the UE,
at least one of the amount of the sensing resolution or the amount of the sensing accuracy for motion tracking in the first BWP, or
the number of sensing targets for the sensing operation, wherein to operate in the first BWP of the number of BWPs, the at least one processor is configured to switch from a second BWP of the number of BWPs to the first BWP, and wherein the number of layers that is selected corresponds to the number of sensing targets for the sensing operation.

4. The apparatus of claim 1, wherein the set of layer parameters is associated with (1) a single resource for communication operations and the sensing operation or (2) a first resource for the communication operations and a second resource for the sensing operation.

5. The apparatus of claim 4, wherein the set of layer parameters is associated with the single resource for the communication operations and the sensing operation, wherein the set of layer parameters includes a first layer parameter for a first maximum number of layers in the communication operations and a second layer parameter for a second maximum number of layers in the sensing operation, and wherein to select the number of layers for the sensing operation, the at least one processor is configured to select the number of layers for the sensing operation as a minimum of the first maximum number of layers and the second maximum number of layers.

6. The apparatus of claim 5, wherein the at least one processor is further configured to:
transmit, for a network node, a conflict indication associated with the first maximum number of layers and the second maximum number of layers through at least one of UE assistance information (UAI) via a medium access control (MAC) control element (MAC-CE) or uplink control information (UCI) via a physical uplink control channel (PUCCH).

7. The apparatus of claim 1, wherein the set of layer parameters corresponds to the maximum number of layers for a first cell of the number of cells associated with the UE and for a first BWP of the number of BWPs utilized for the MIMO JCS by the UE, and
wherein the set of layer parameters includes a first layer parameter for a first maximum number of layers associated with monostatic sensing and a second layer parameter for a second maximum number of layers associated with bistatic sensing.

8. The apparatus of claim 7, wherein the first layer parameter for the first maximum number of layers associated with the monostatic sensing has a value that is higher than the second layer parameter for the second maximum number of layers associated with the bistatic sensing; or
wherein the first layer parameter for the first maximum number of layers associated with the monostatic sensing is unconstrained during the sensing operation when the sensing operation is monostatic.

9. The apparatus of claim 1, wherein a BWP of the number of BWPs is configured for monostatic sensing and bistatic sensing, wherein the set of layer parameters includes a first layer parameter for a first maximum number of layers associated with the monostatic sensing and a second layer parameter for a second maximum number of layers associated with the bistatic sensing, and wherein to select the number of layers for the sensing operation, the at least one processor is configured to select the number of layers for the sensing operation as a minimum of the first maximum number of layers and the second maximum number of layers.

10. The apparatus of claim 1, wherein a BWP of the number of BWPs is configured for monostatic sensing and bistatic sensing, wherein the set of layer parameters includes a first layer parameter for a first maximum number of layers associated with the monostatic sensing and a second layer parameter for a second maximum number of layers associated with the bistatic sensing that is higher than the first maximum number of layers, and wherein to select the number of layers for the sensing operation, the at least one processor is configured to select the number of layers for the sensing operation as the second maximum number of layers based on a UE capability.

11. The apparatus of claim 1, wherein the at least one processor is further configured to:
transmit, for a network node, an indication of a UE capability of the UE associated with the MIMO JCS;
wherein to obtain the set of layer parameters for the MIMO JCS, the at least one processor is configured to: receive, from the network node, the set of layer parameters based on the UE capability.

12. (canceled)

13. The apparatus of claim 1, wherein to obtain the set of layer parameters for the MIMO JCS, the at least one processor is configured to: select the set of layer parameters from a list of layer parameters.

14. The apparatus of claim 1, wherein the at least one processor is further configured to:
measure other sensing measurement data associated with at least one other sensing target for at least one other sensing operation prior to obtaining the set of layer parameters for the MIMO JCS;
wherein to measure the sensing measurement data, the at least one processor is configured to measure the sensing measurement data, based on the MIMO sensing configuration, with at least one of a different BWP or a different sensing operation type compared to measuring the other sensing measurement data associated with the at least one other sensing target for the at least one other sensing operation.

15. An apparatus for wireless communication at a network node, comprising:
a memory; and
at least one processor coupled to the memory and, based at least in part on information stored in the memory, the at least one processor is configured to:
receive, from a user equipment (UE), an indication of a UE capability associated with multiple-input multiple-output (MIMO) joint communication and sensing (JCS); and
configure the UE, based on the indication of the UE capability, with a MIMO sensing configuration that indicates a set of layer parameters for the MIMO JCS, wherein the set of layer parameters corresponds to a maximum number of layers for at least one of a number of cells associated with the UE or a number of bandwidth parts (BWPs) utilized for the MIMO JCS by the UE.

16. The apparatus of claim 15, wherein each of the number of BWPs utilized for the MIMO JCS by the UE is a physical resource block (PRB), wherein each PRB is configured by the MIMO sensing configuration via radio resource control (RRC) signaling, and wherein each PRB is configured by the MIMO sensing configuration with a respective layer parameter value for one or more layer parameters in the set of layer parameters.

17-19. (canceled)

20. The apparatus of claim 15, wherein the set of layer parameters corresponds to the maximum number of layers for a first cell of the number of cells associated with the UE and for a first BWP of the number of BWPs utilized for the MIMO JCS by the UE, and
wherein the set of layer parameters includes a first layer parameter for a first maximum number of layers associated with monostatic sensing and a second layer parameter for a second maximum number of layers associated with bistatic sensing.

21. (canceled)

22. The apparatus of claim 15, wherein a BWP of the number of BWPs is configured for monostatic sensing and bistatic sensing by the MIMO sensing configuration, wherein the set of layer parameters includes a first layer parameter for a first maximum number of layers associated with the monostatic sensing and a second layer parameter for a second maximum number of layers associated with the bistatic sensing, and wherein a selection of a number of layers for a sensing operation comprises the selection of the number of layers for the sensing operation as a minimum of the first maximum number of layers and the second maximum number of layers.

23. The apparatus of claim 15, wherein a BWP of the number of BWPs is configured for monostatic sensing and bistatic sensing, wherein the set of layer parameters includes a first layer parameter for a first maximum number of layers associated with the monostatic sensing and a second layer parameter for a second maximum number of layers associated with the bistatic sensing that is higher than the first maximum number of layers based on the UE capability.

24. (canceled)

25. The apparatus of claim 15, wherein the at least one processor is further configured to:
select a number of layers for a sensing operation based on at least one of the set of layer parameters or an operational condition of the UE associated with the indication of the UE capability, wherein the sensing operation is associated with the MIMO JCS; and
measure sensing measurement data associated with at least one sensing target for the sensing operation according to the number of layers.

26-27. (canceled)

28. A method of wireless communication at a user equipment (UE), comprising:
obtaining a set of layer parameters for multiple-input multiple-output (MIMO) joint communication and sensing (JCS) based on a MIMO sensing configuration, wherein the set of layer parameters corresponds to a maximum number of layers for at least one of a number of cells associated with the UE or a number of bandwidth parts (BWPs) utilized for the MIMO JCS by the UE;
selecting a number of layers for a sensing operation based on the set of layer parameters and an operational condition, wherein the sensing operation is associated with the MIMO JCS by the UE; and
measuring sensing measurement data associated with at least one sensing target for the sensing operation according to the number of layers.

29-30. (canceled)
